(19) United States
(12) Patent Application Publication
(10) Pub. No.: US 2007/0244707 A1
(43) Pub. Date: Oct. 18, 2007

(54) Adaptable device for spatial and nonspatial considerations

(76) Inventor: Michael Bickelmeyer, Parma, OH (US)

Correspondence Address: Michael Bickelmeyer, 4029 Memphis Ave. Apt, 2, Cleveland, OH, 44109, US

(21) Appl. No.: 11/390,652

(22) Filed: Mar. 28, 2006

(51) Int. Cl. G06Q 10/00; G06Q 30/00

(52) U.S. Cl. 705/1

(57) ABSTRACT

An evolutionary and reuseable device which is adaptable for soatial and environmental considerations, adaptable to the dimensions of an existing architectural and or nonarchitectual area and or environment, both made by human and or other, is capable of being modified with and without accessories and apparatusies and other, easily and rapidly by the user by means of human, human made apparatusies and other, and rapidly utilized by the user and expandable utilizing connected space elements of both fixed, nonfixed, variable and nonvariable dimensions.

### FIELD OF THE INVENTION

The device according to the invention is designed, nonexclusively, to endeavor process both interior solid mass, tangible and intangible and intangible on all of an interior sphere, exterior sphere, sphere surface, atmosphere and other.

### BACKGROUND OF THE INVENTION

Usually, process apparatusies are of fixed dimensions and apply to a single purpose. Thus, the small and large variety of interior and exterior apparatusies utilized for process rarely permits area, locative variable apparatusies elements. This entails forthcoming of process delays which are contrary to purposes of process and processies.

The processies, functions, and apparatusies are well defined advantages, to both processies and environments.

### SUMMARY OF THE INVENTION

The present invention remedies these disadvantages by proposing device and devices, both fixed, nonfixed variable, nonvariable, tangible and intangible, used fot both ourpose and in combination of multiple factor purposes.

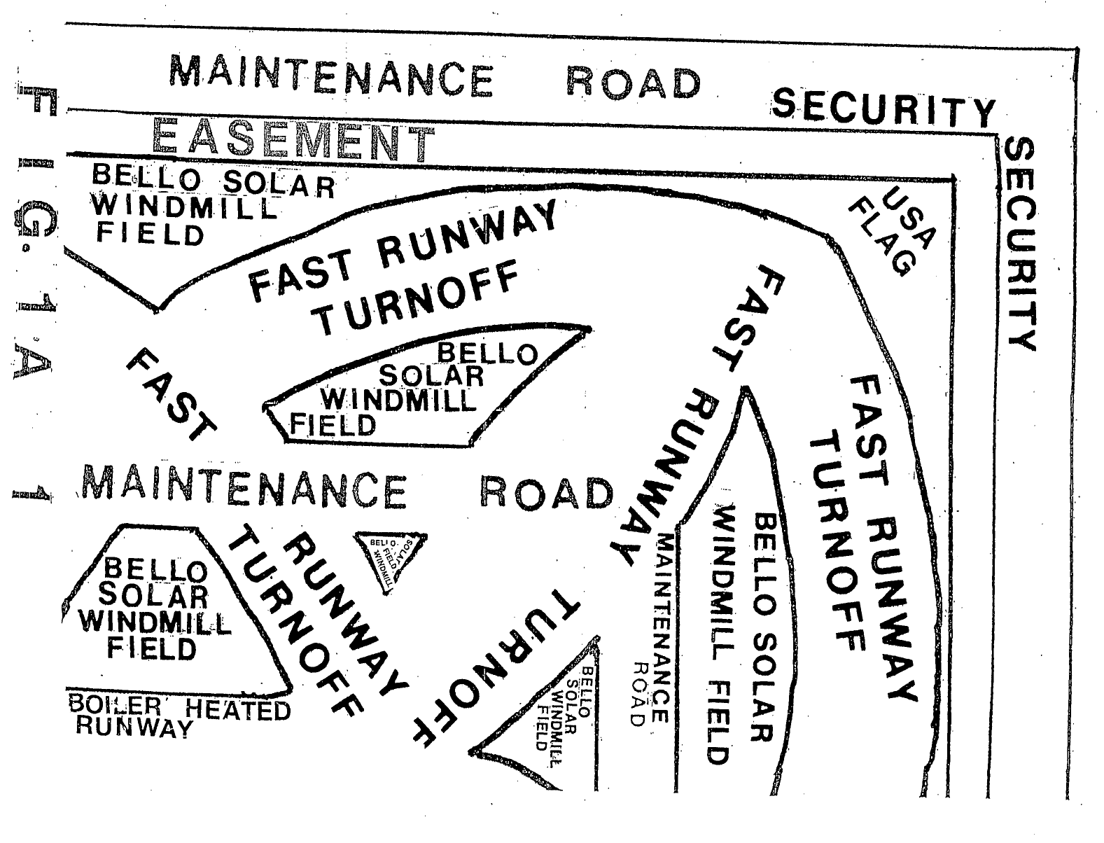

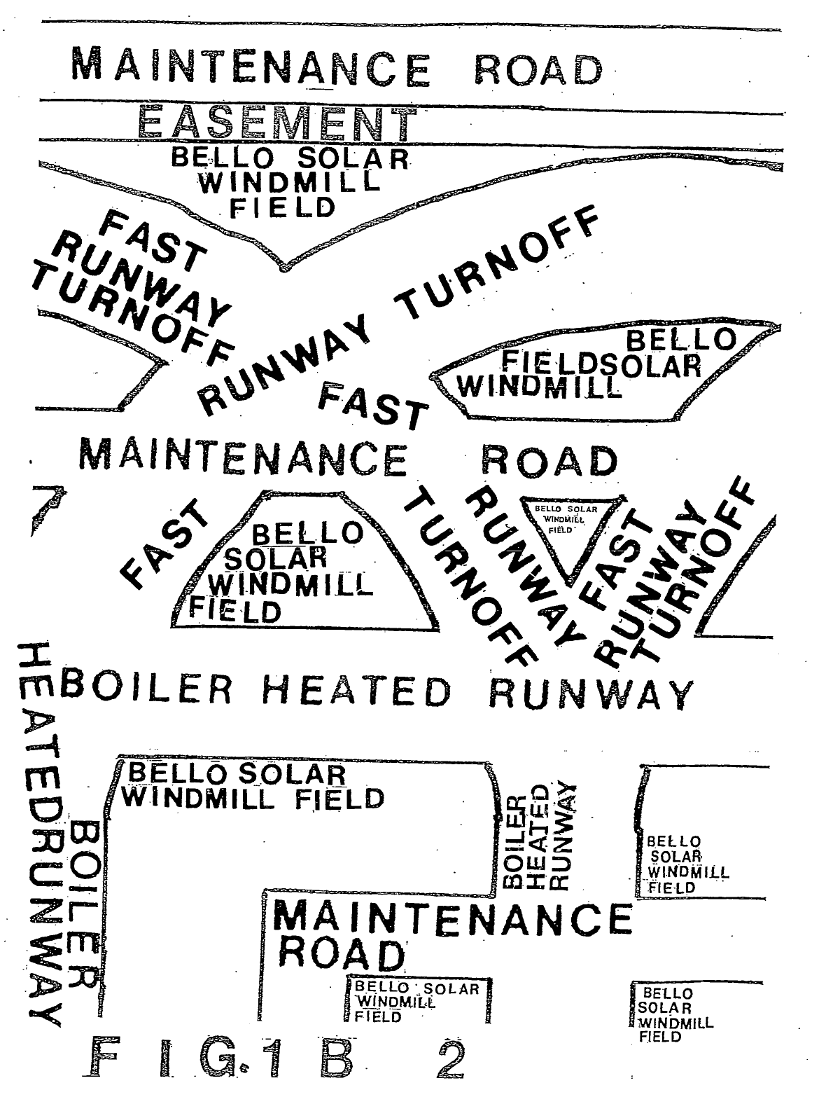

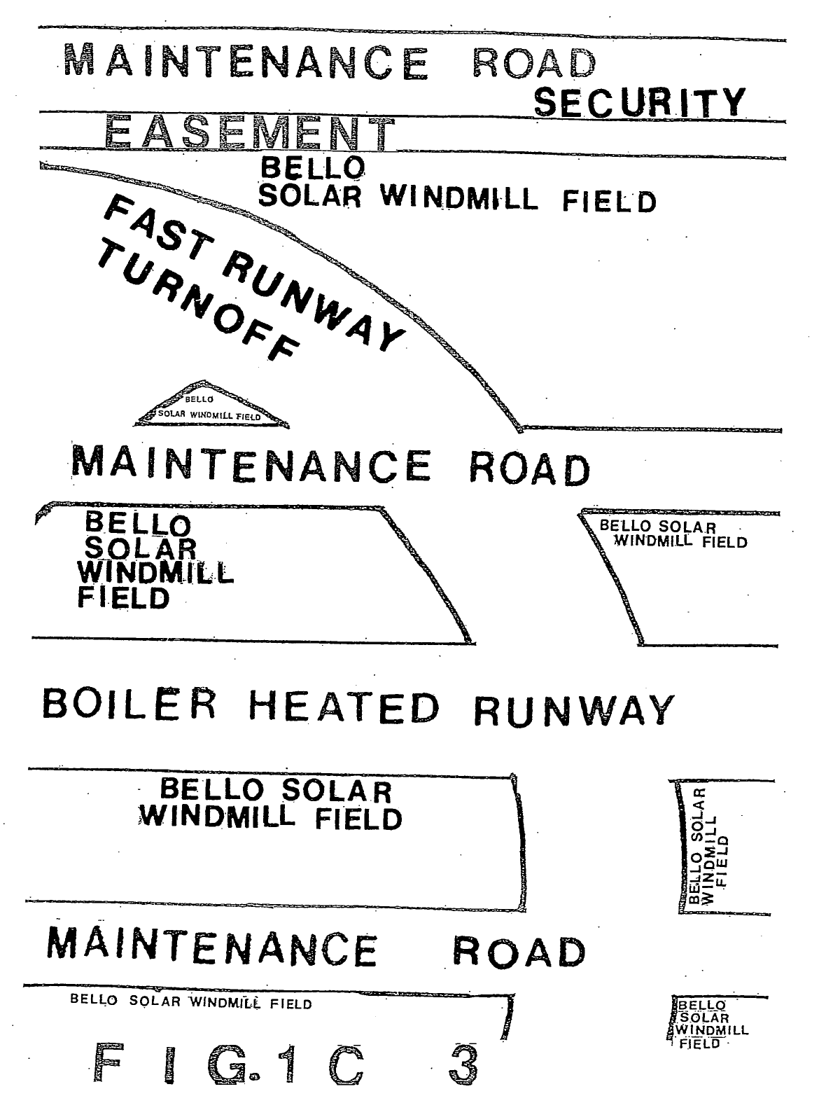

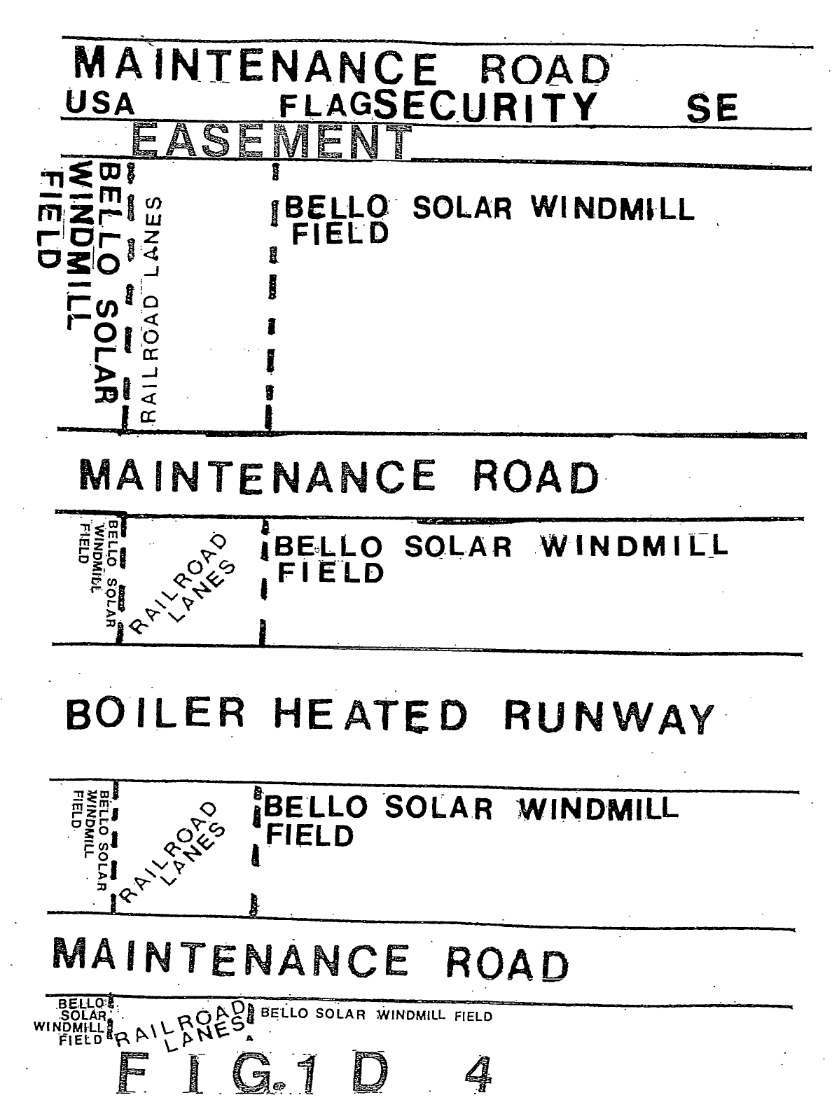

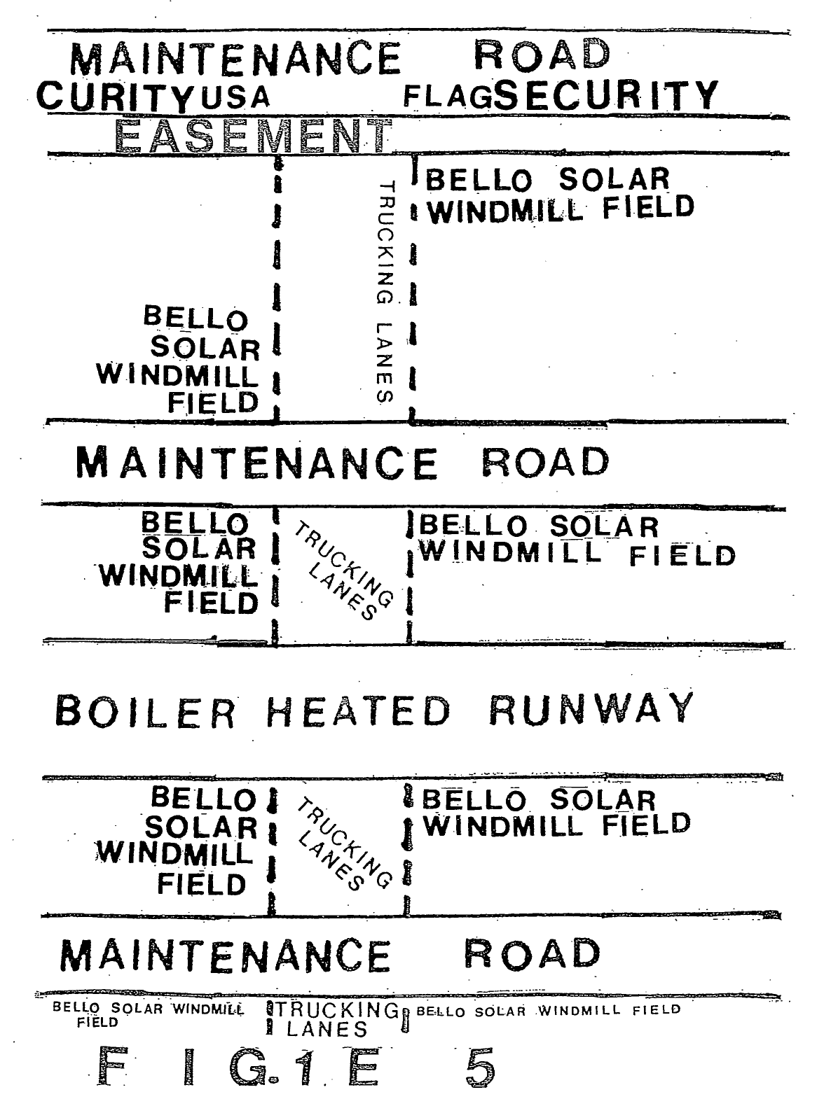

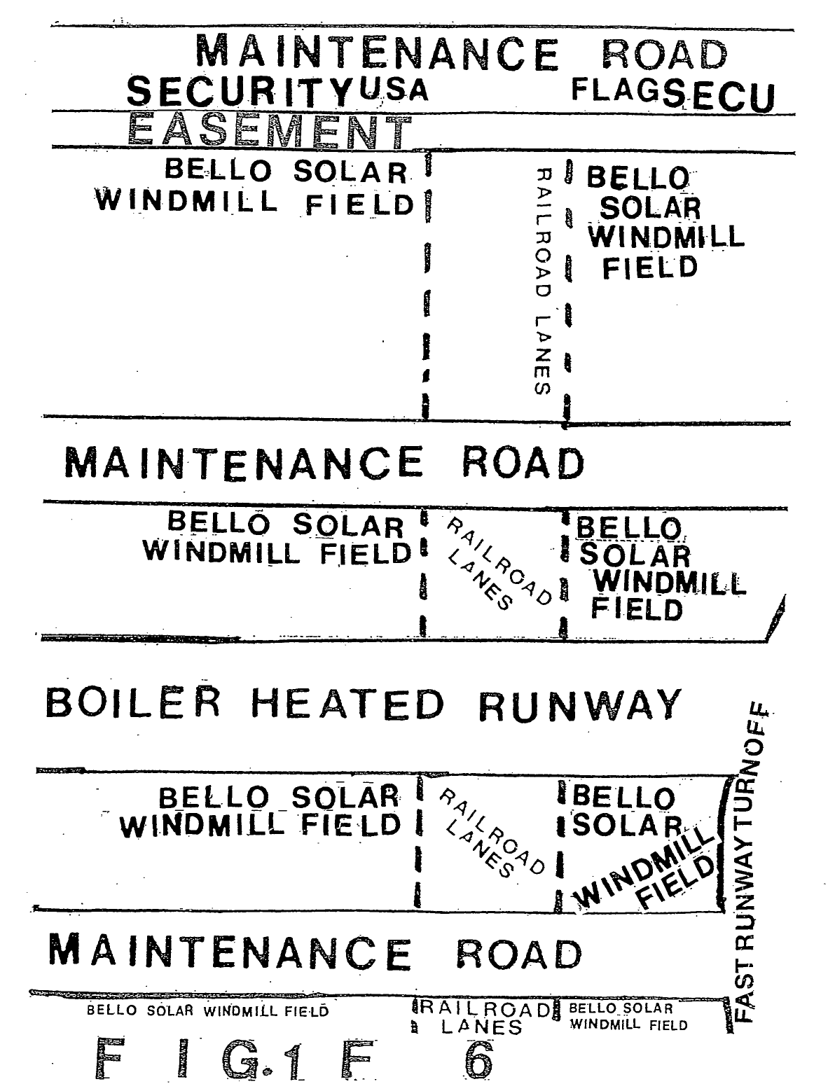

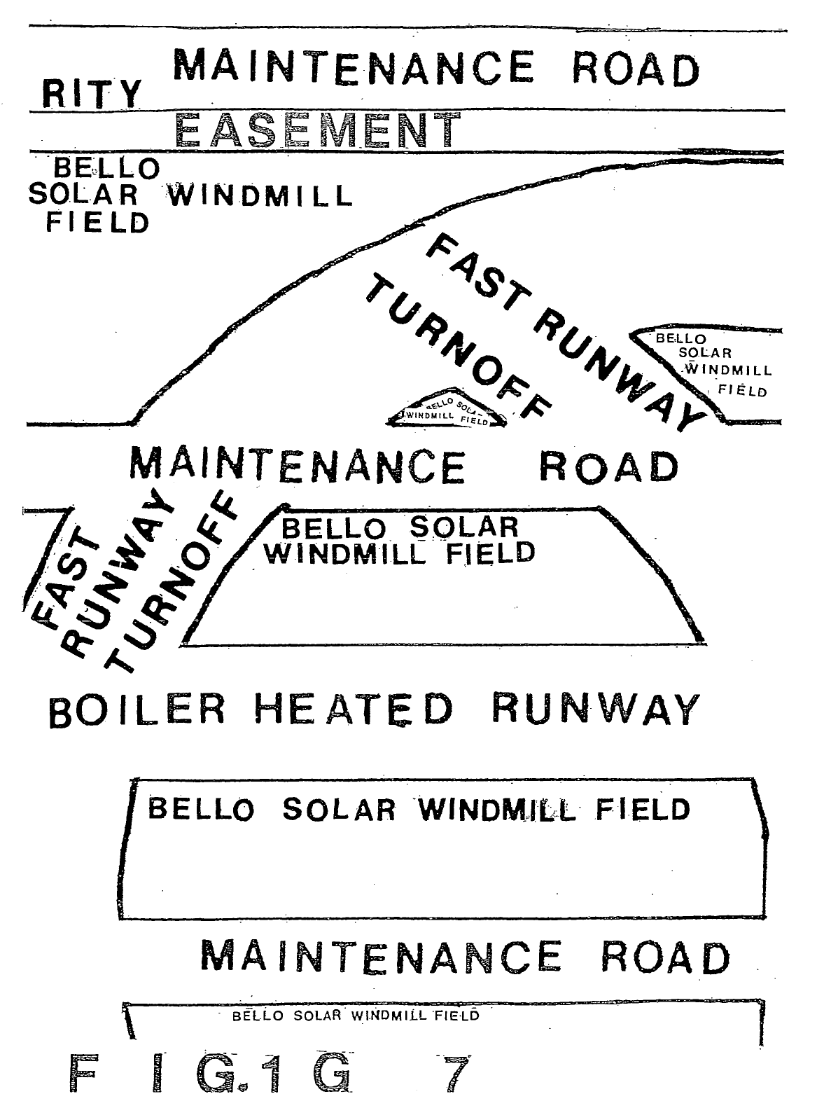

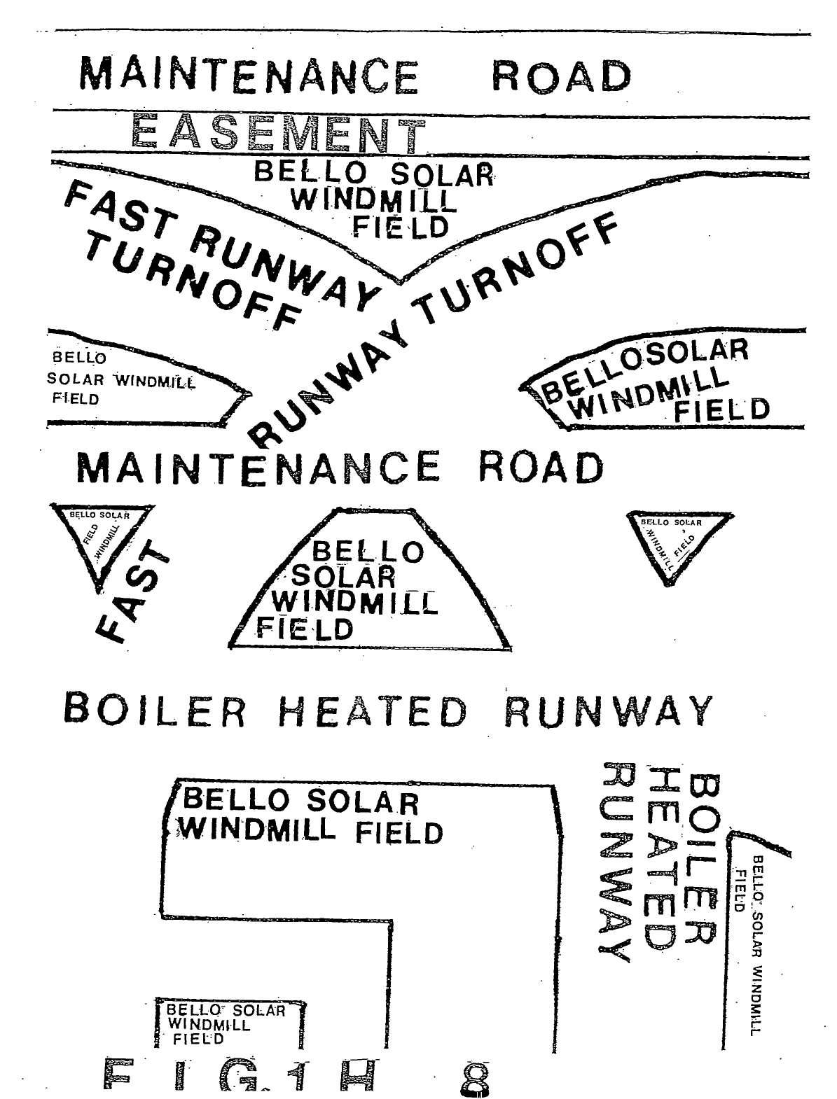

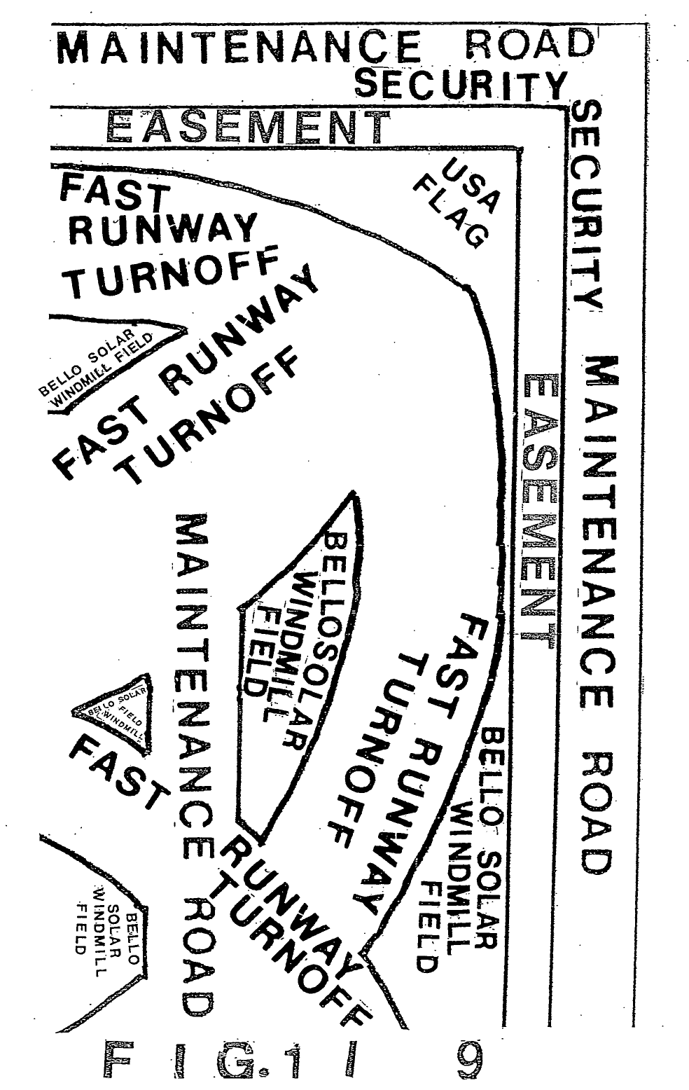

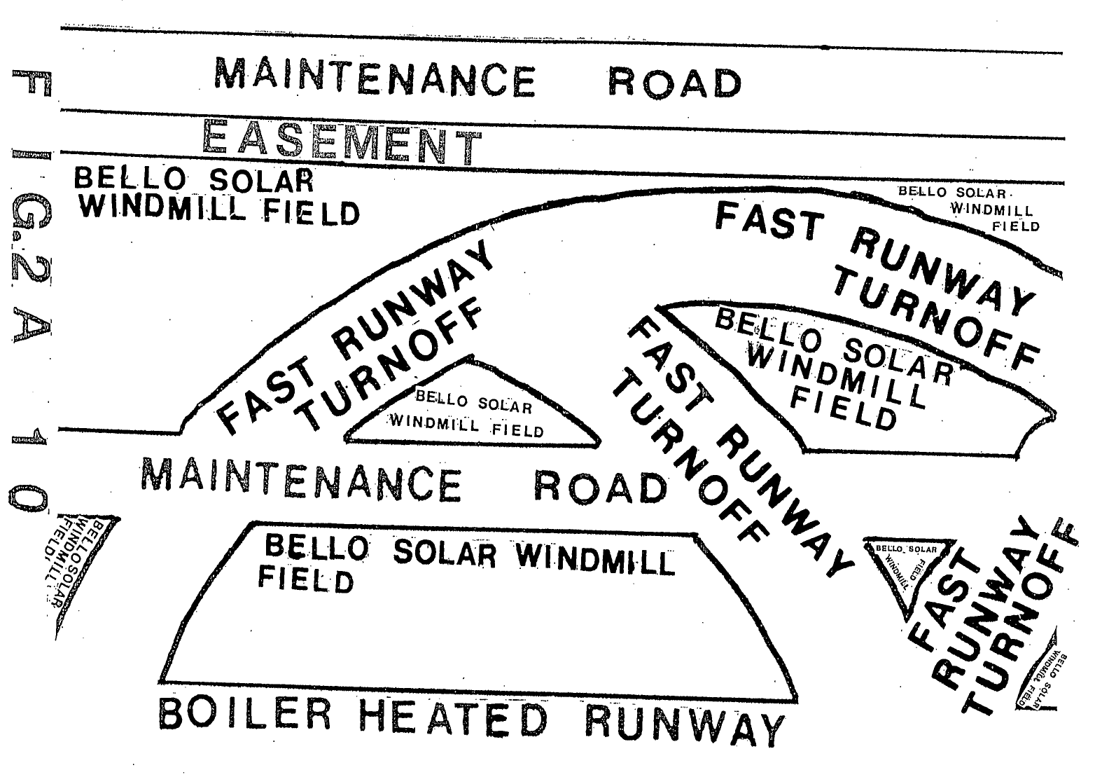

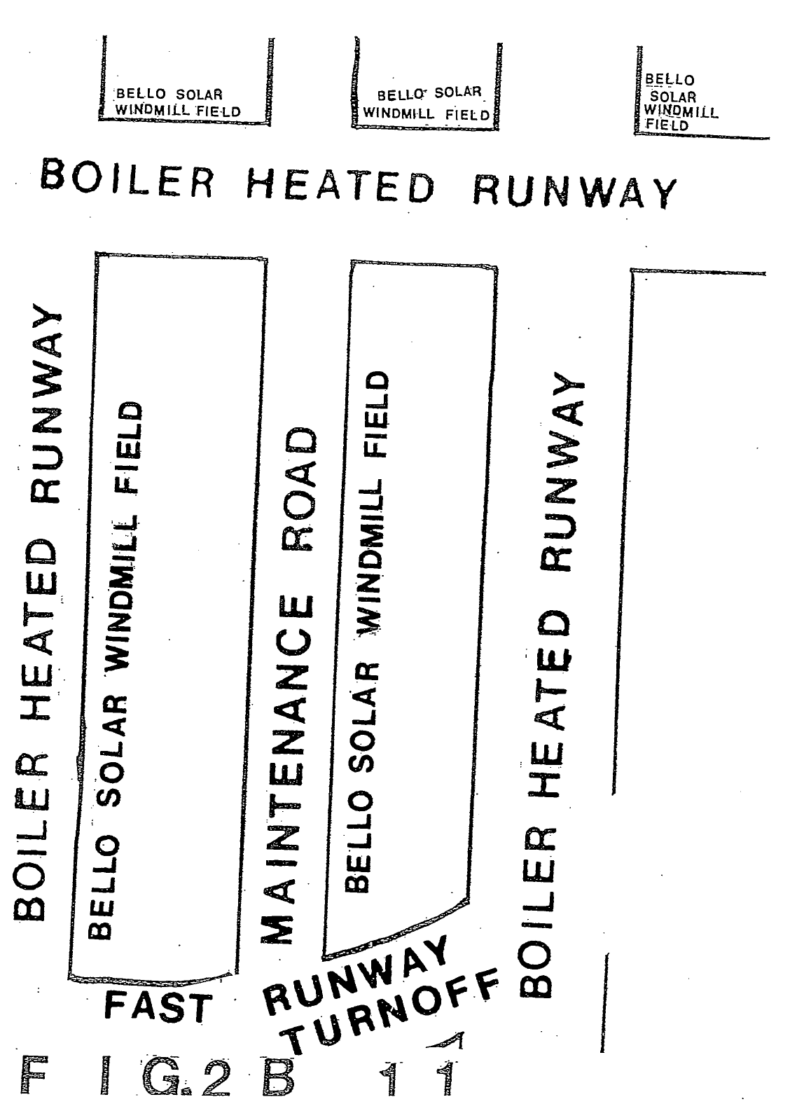

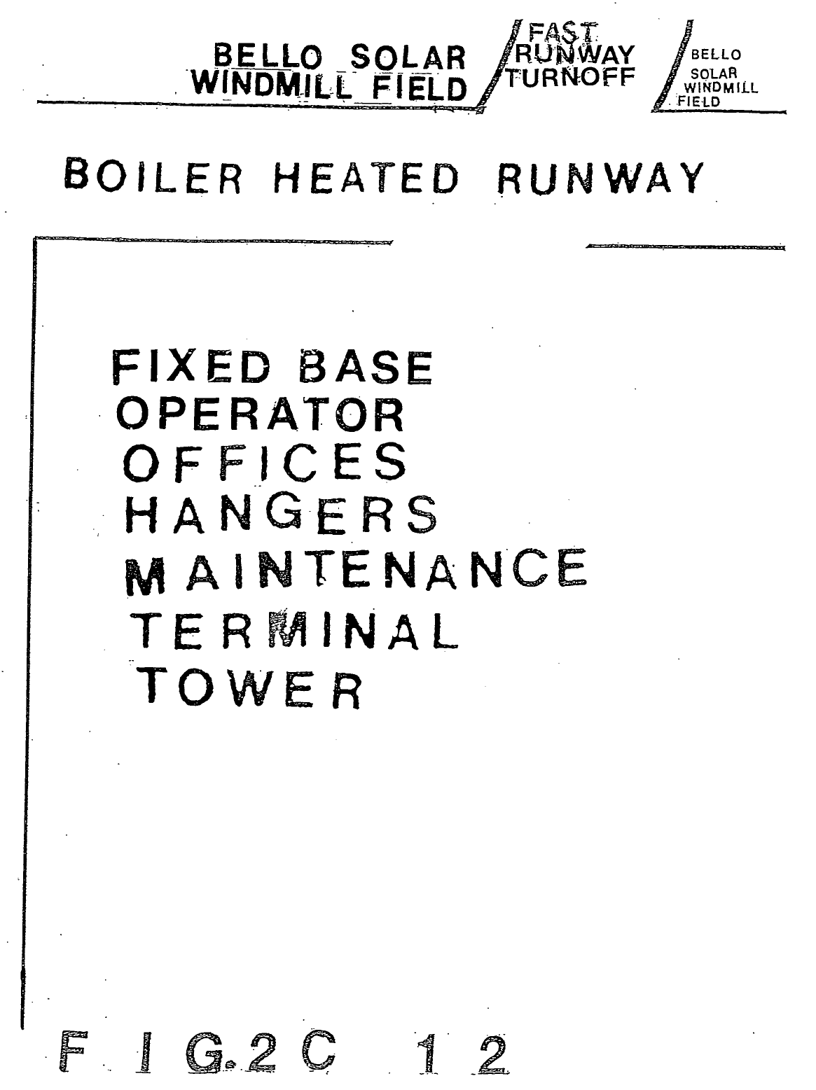

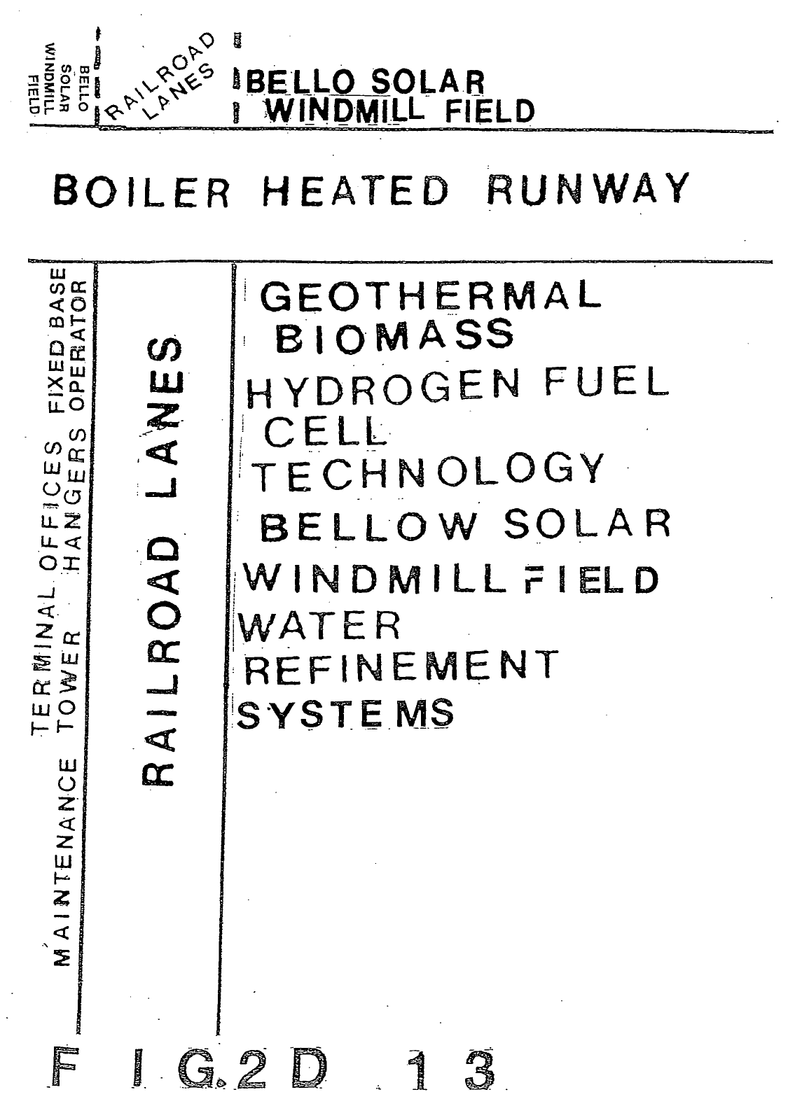

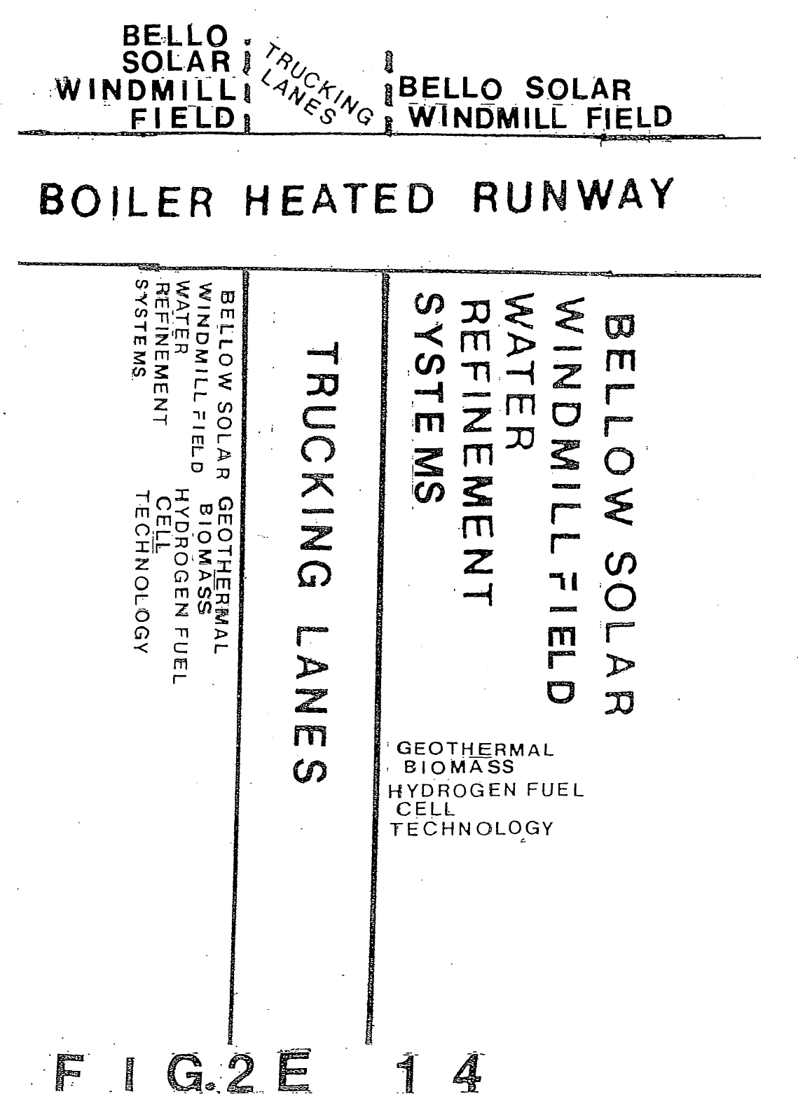

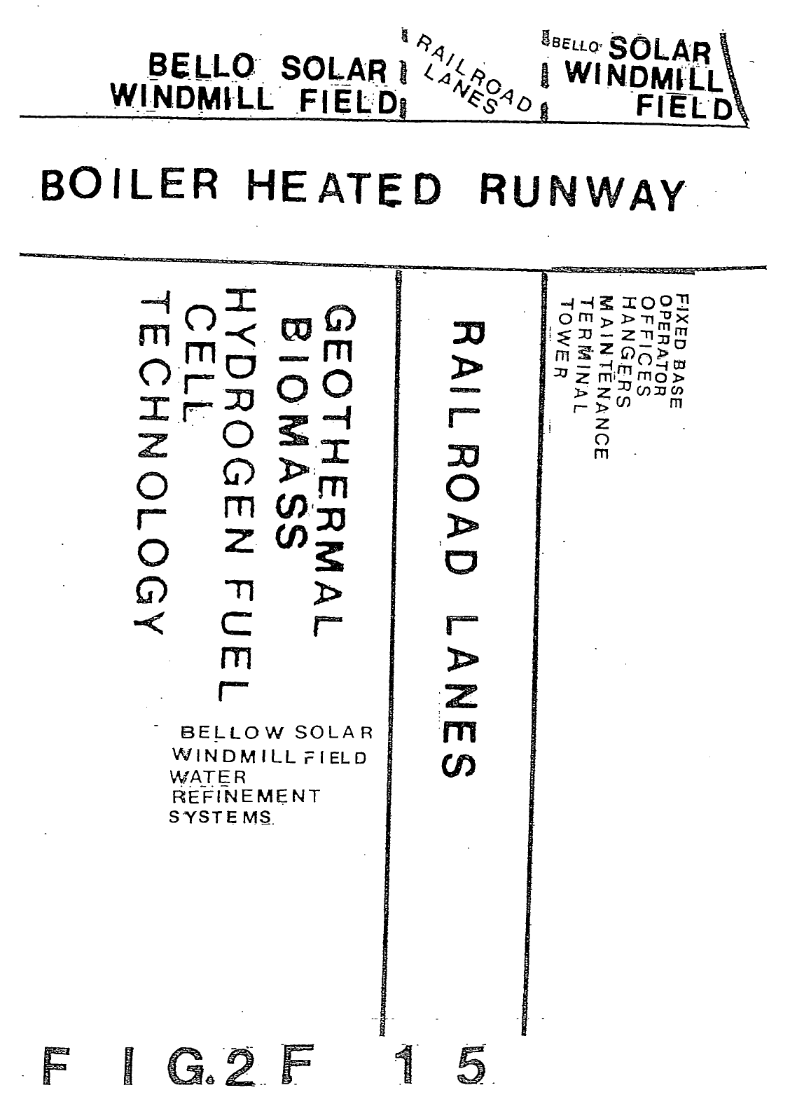

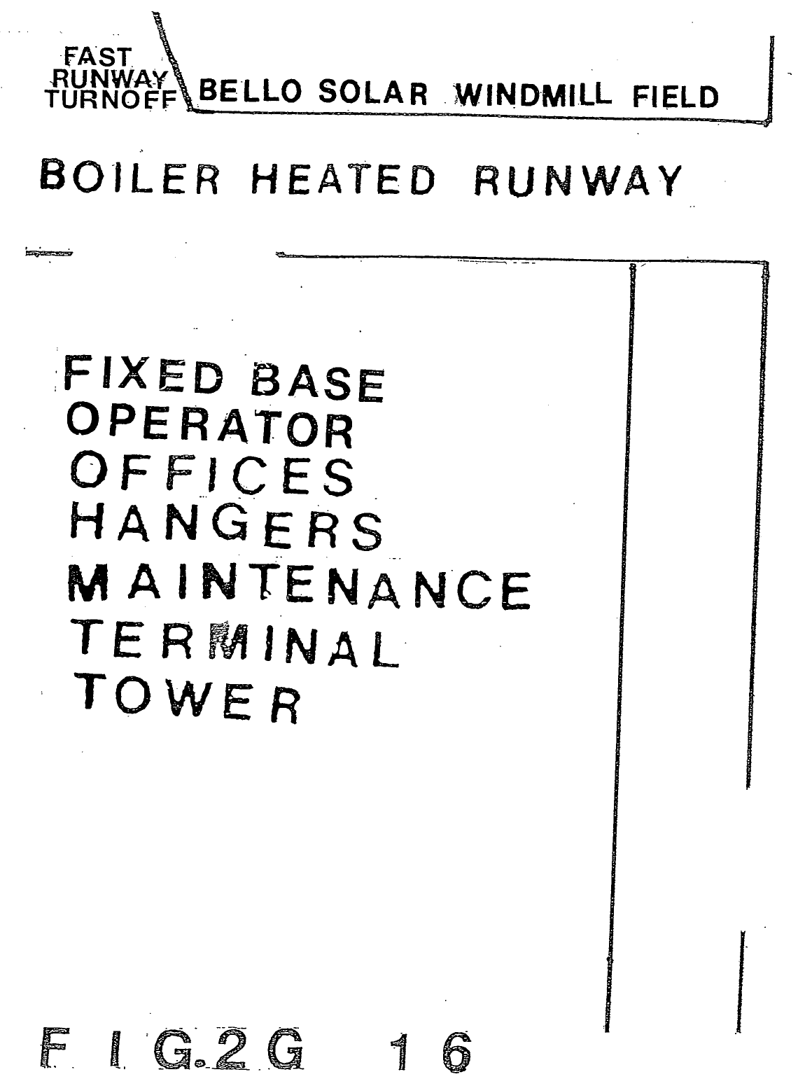

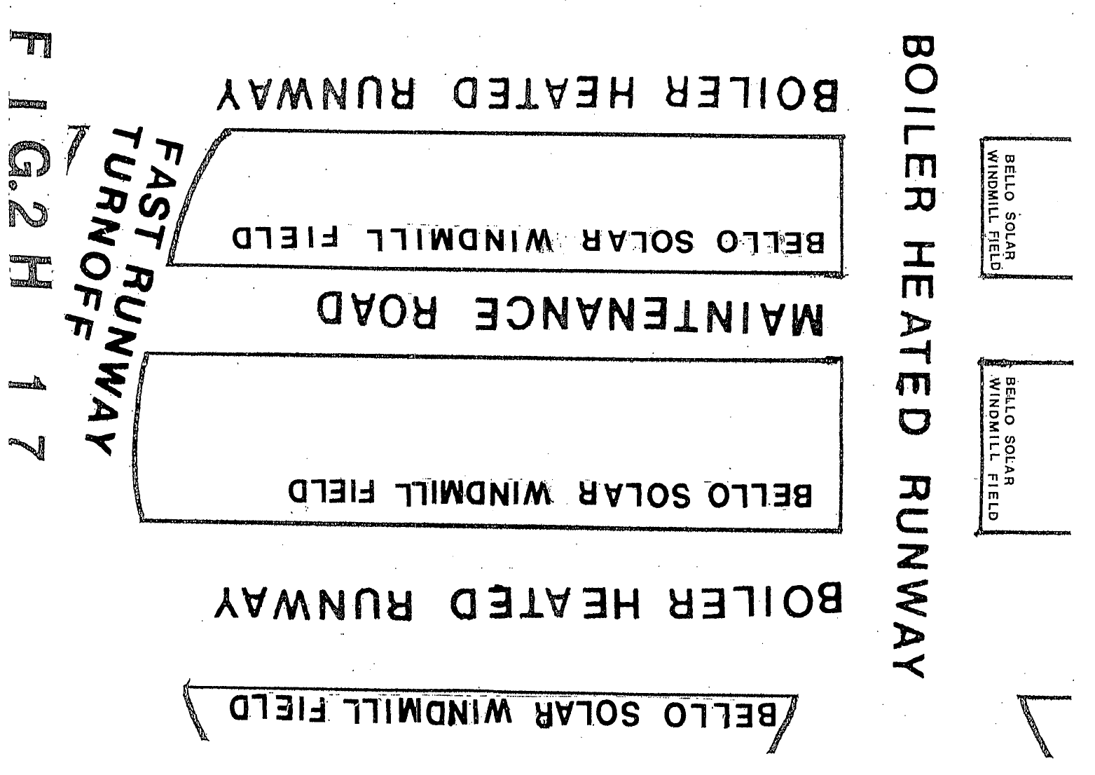

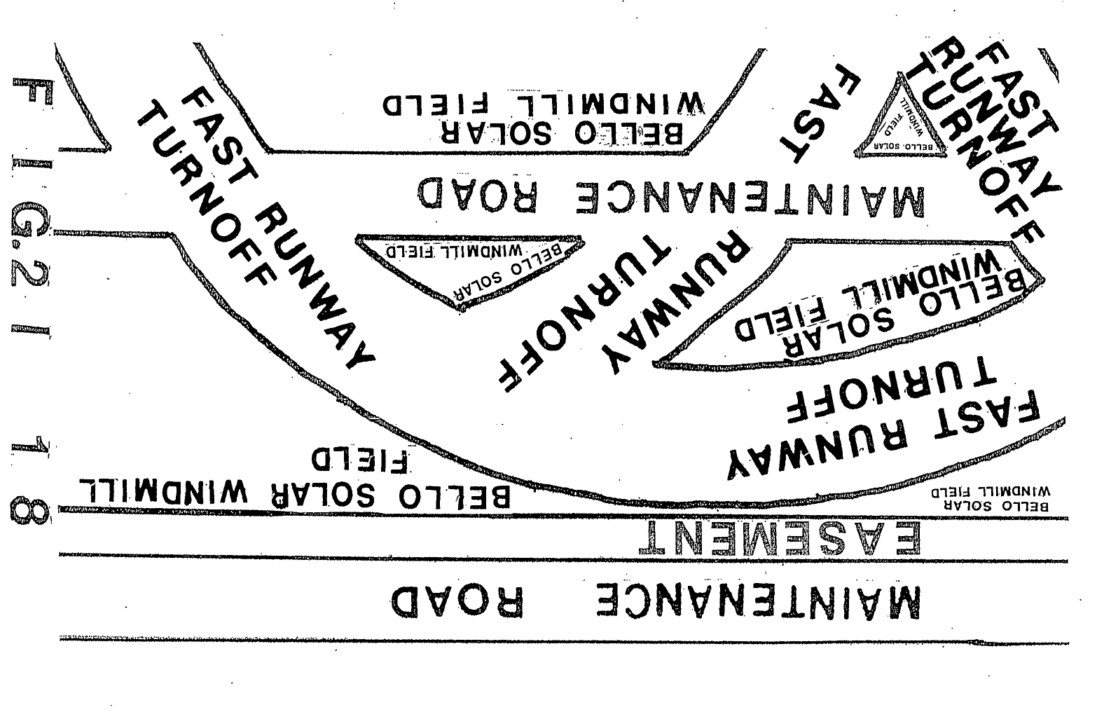

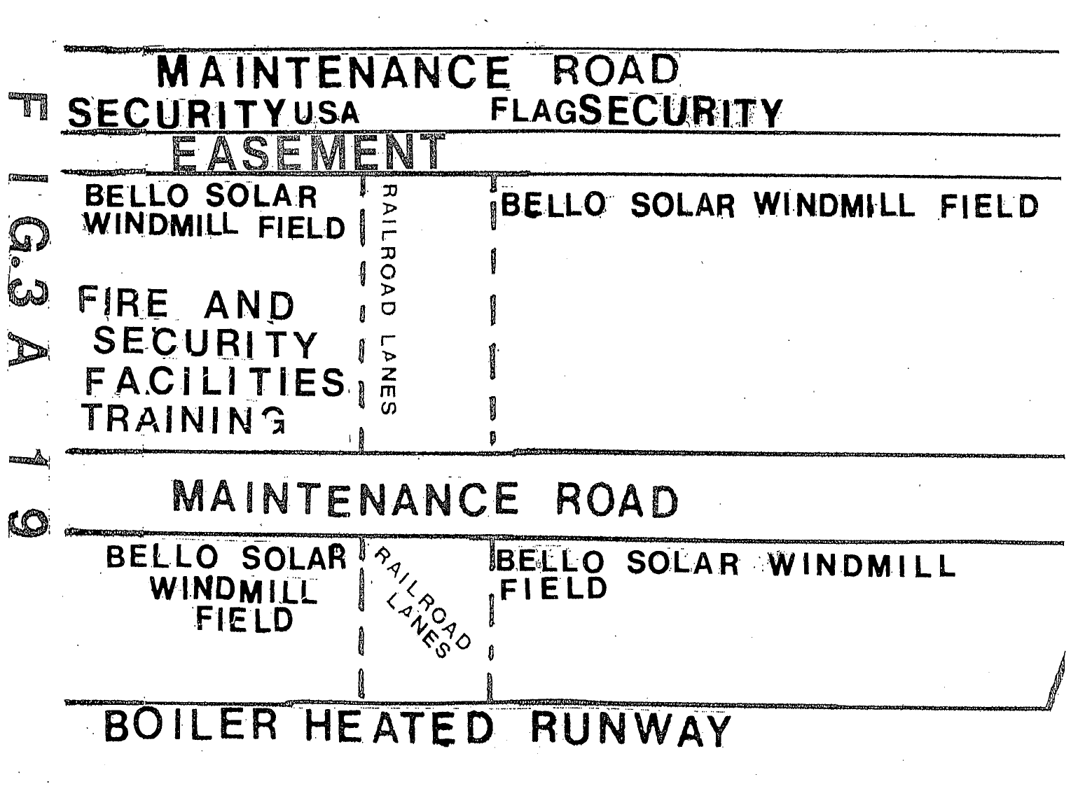

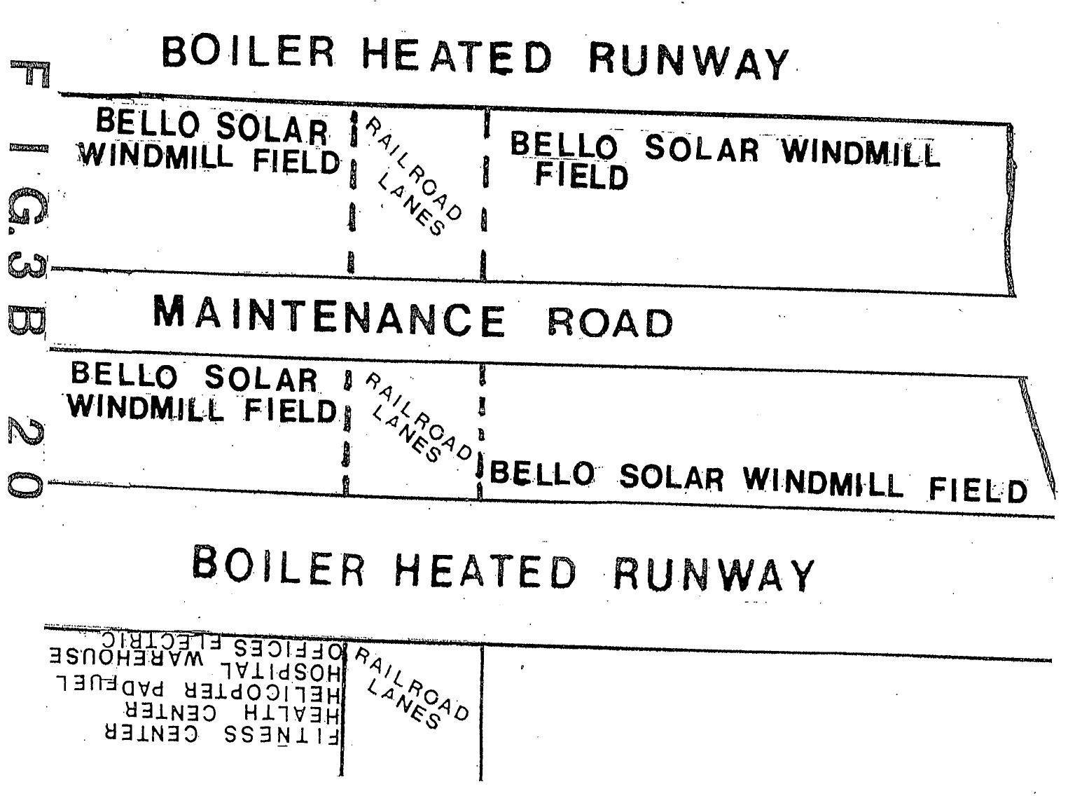

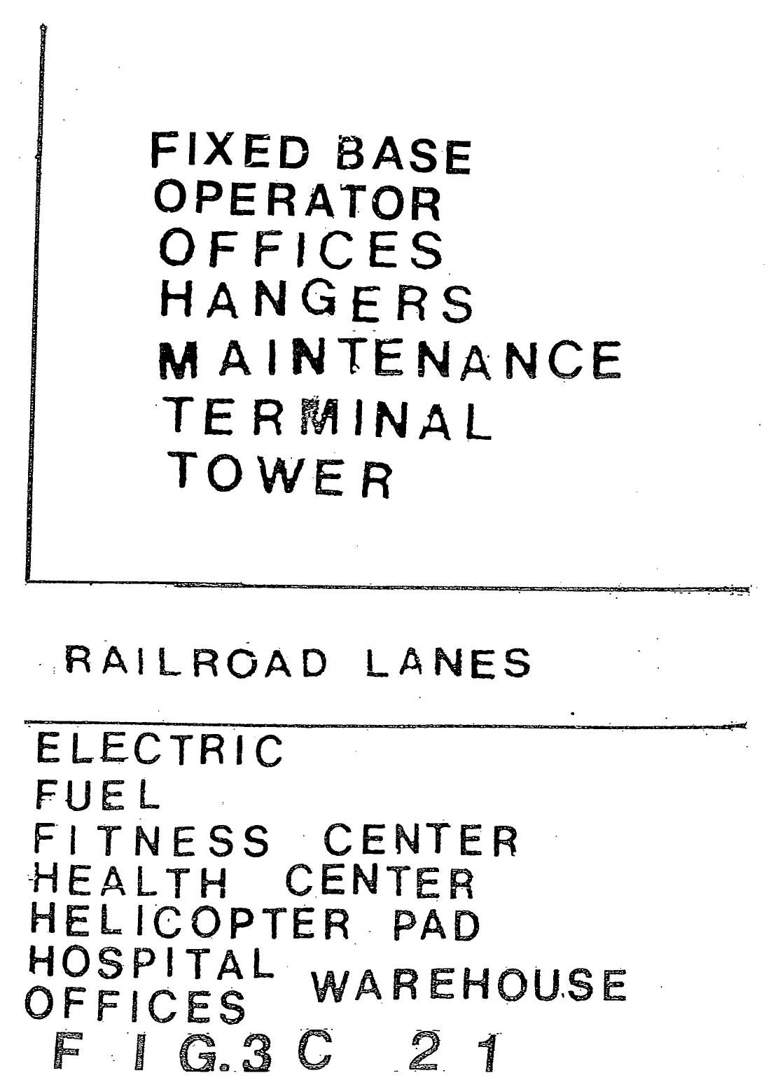

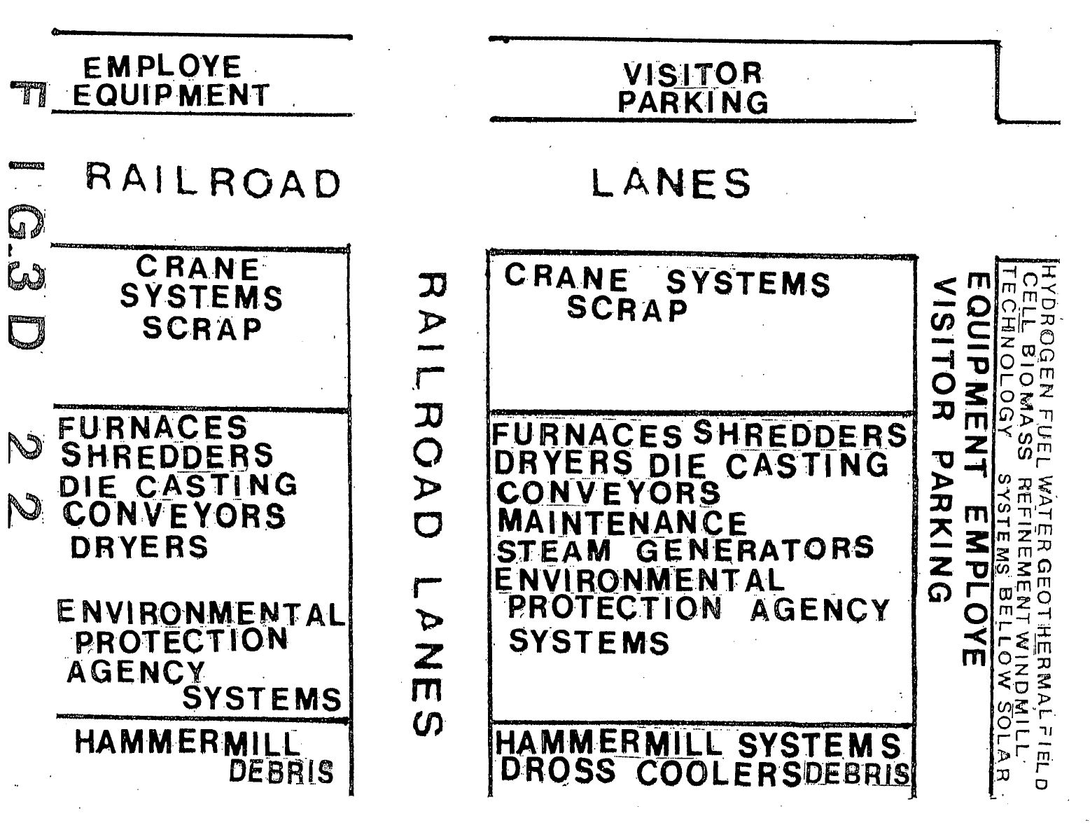

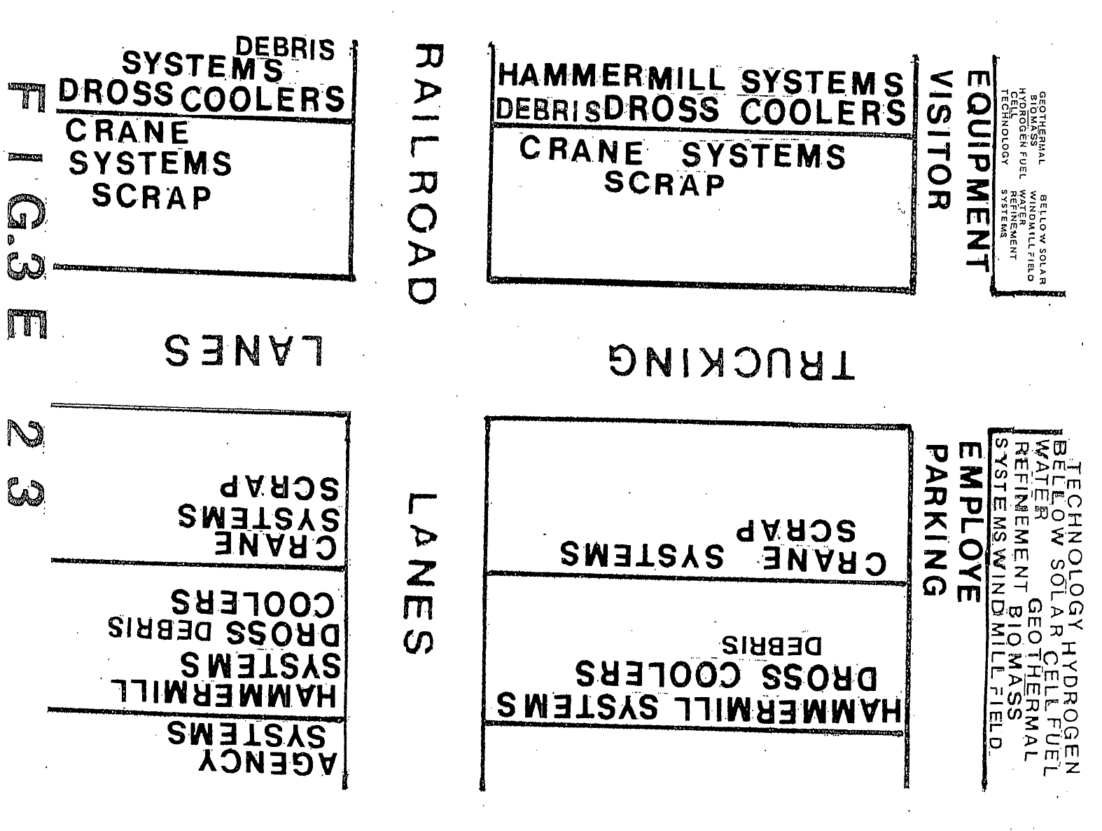

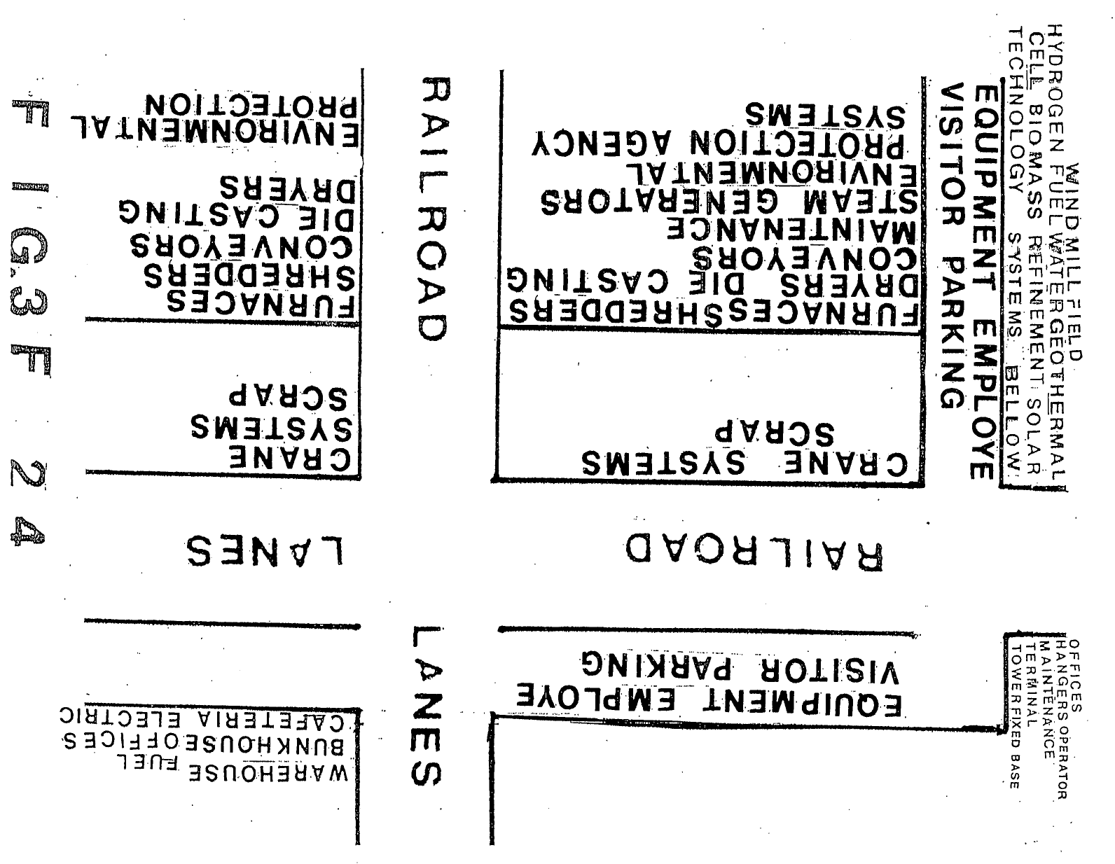

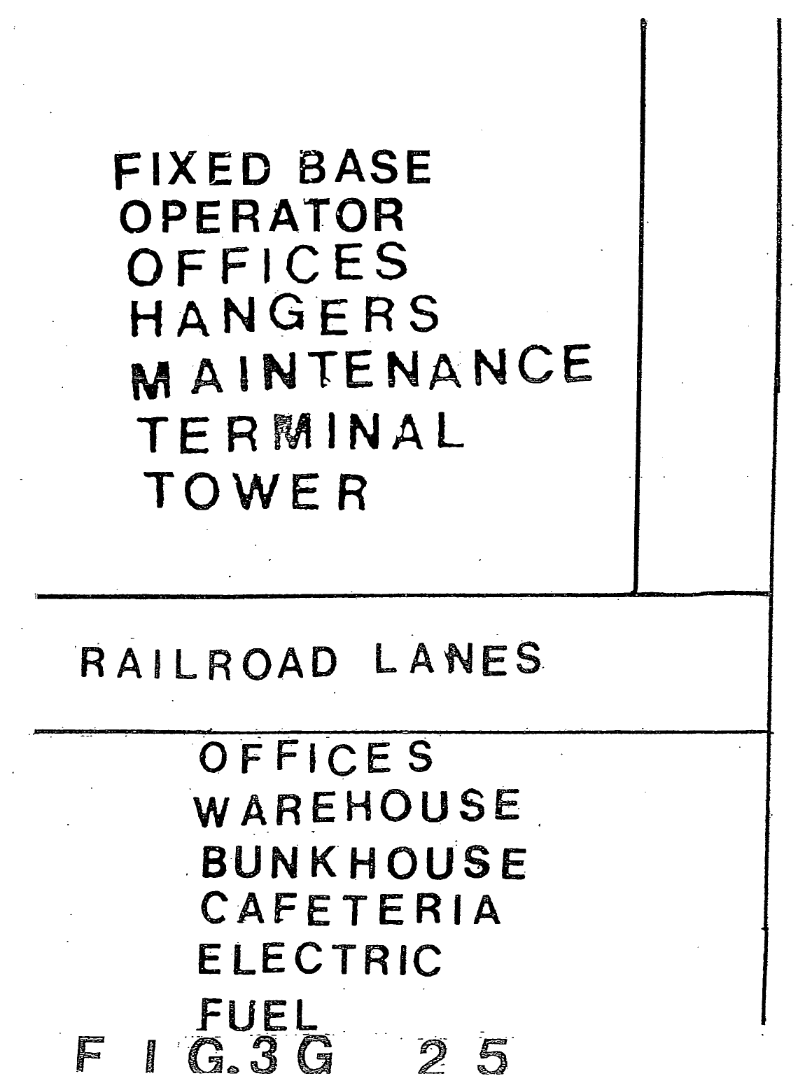

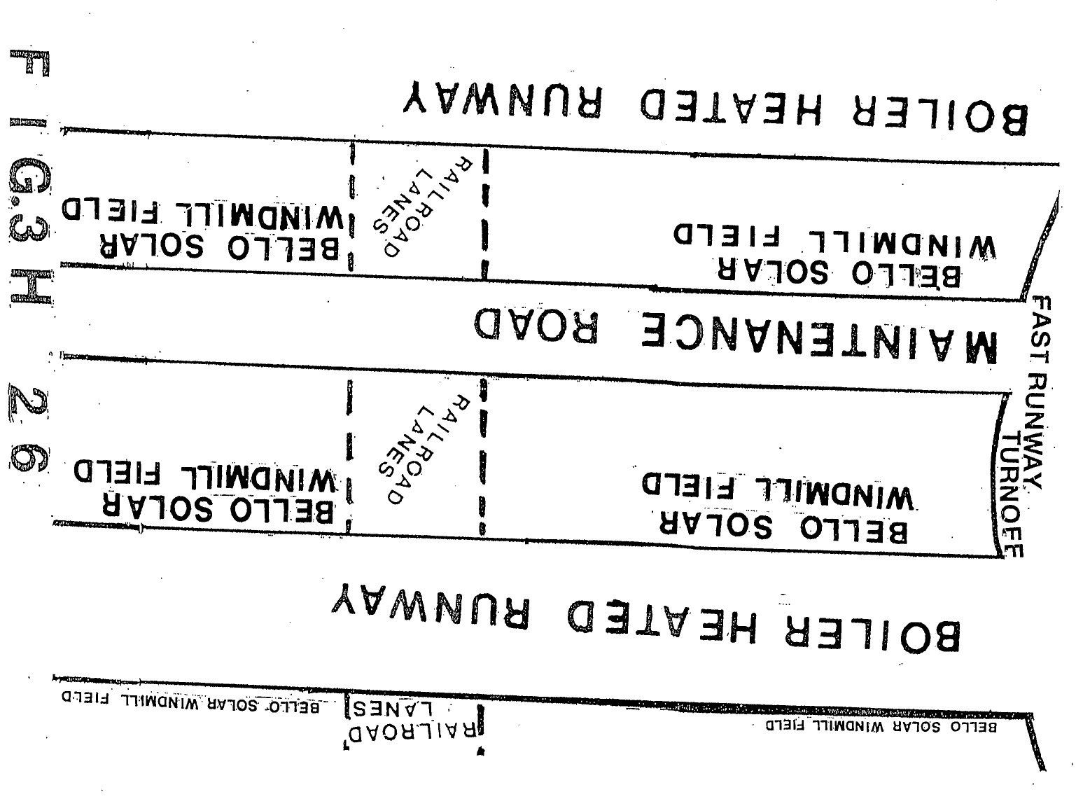

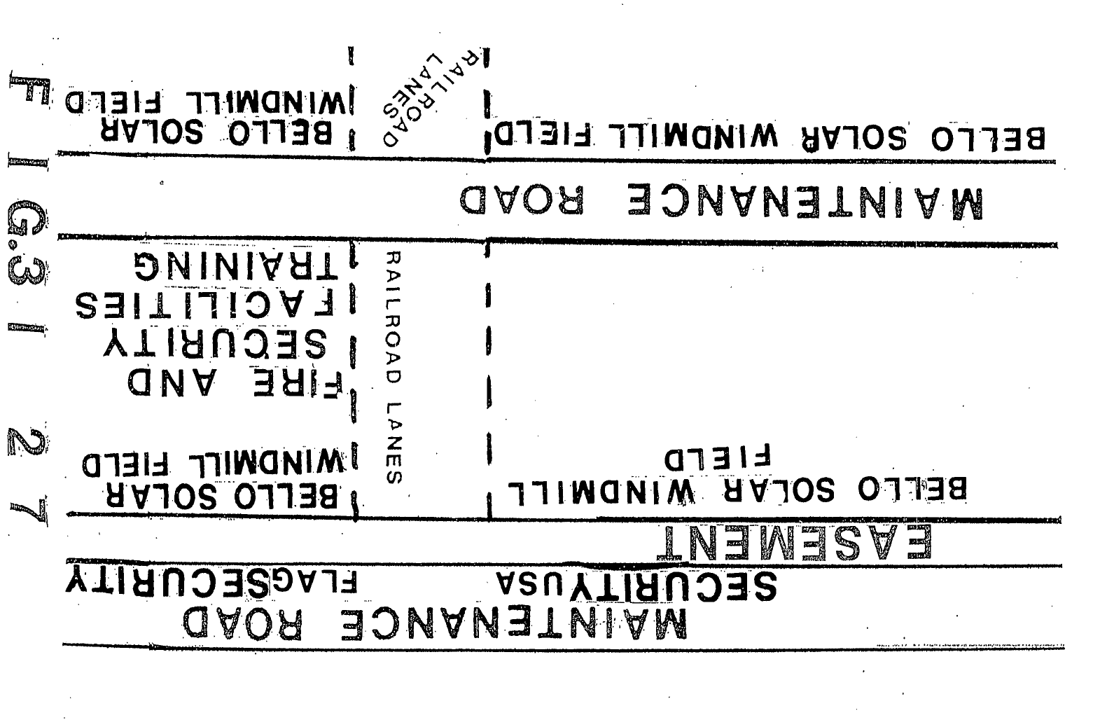

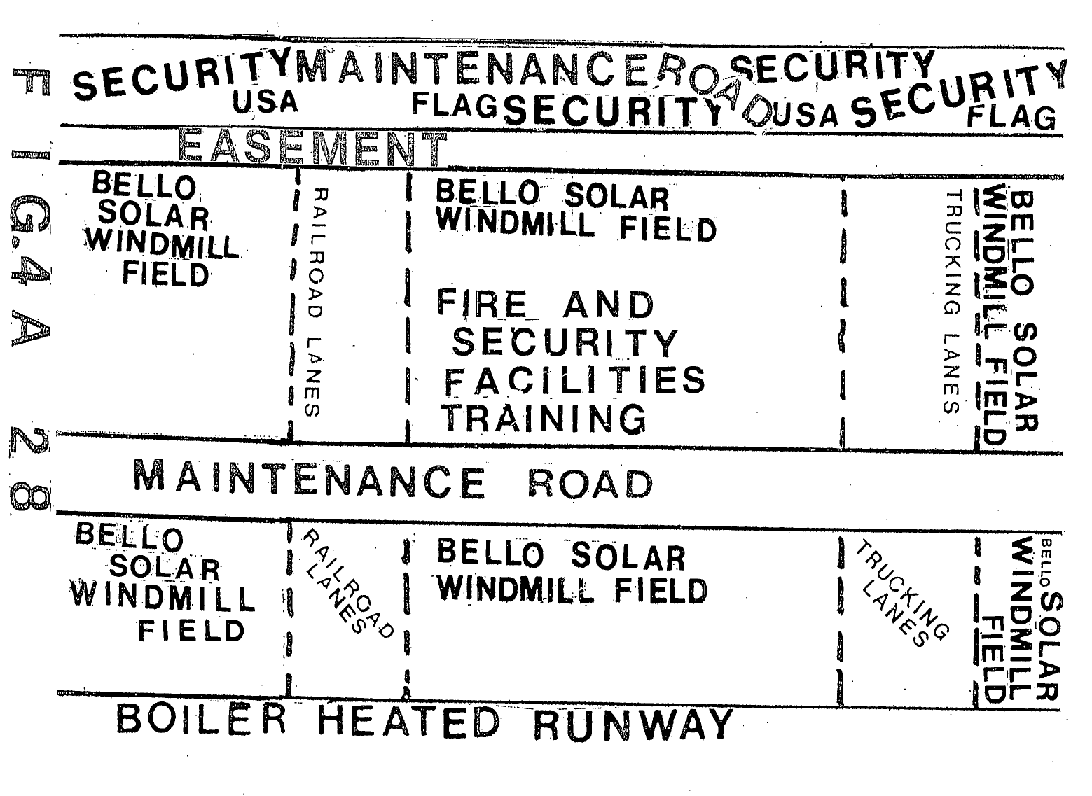

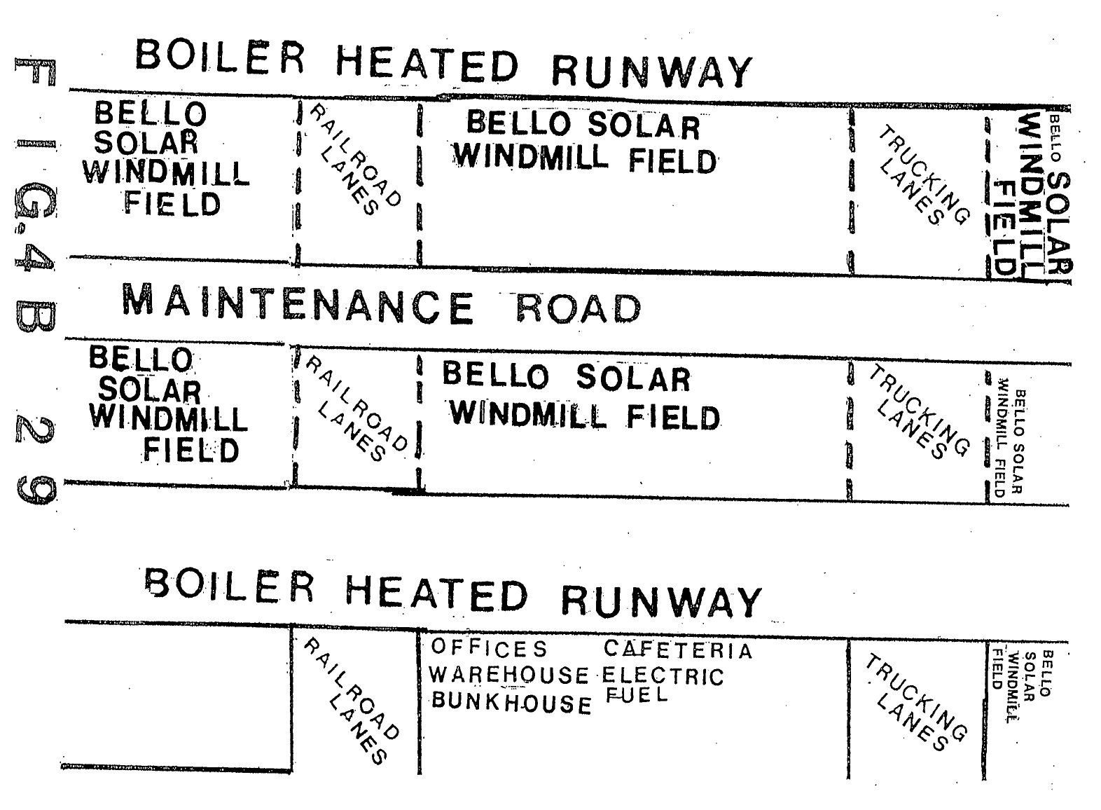

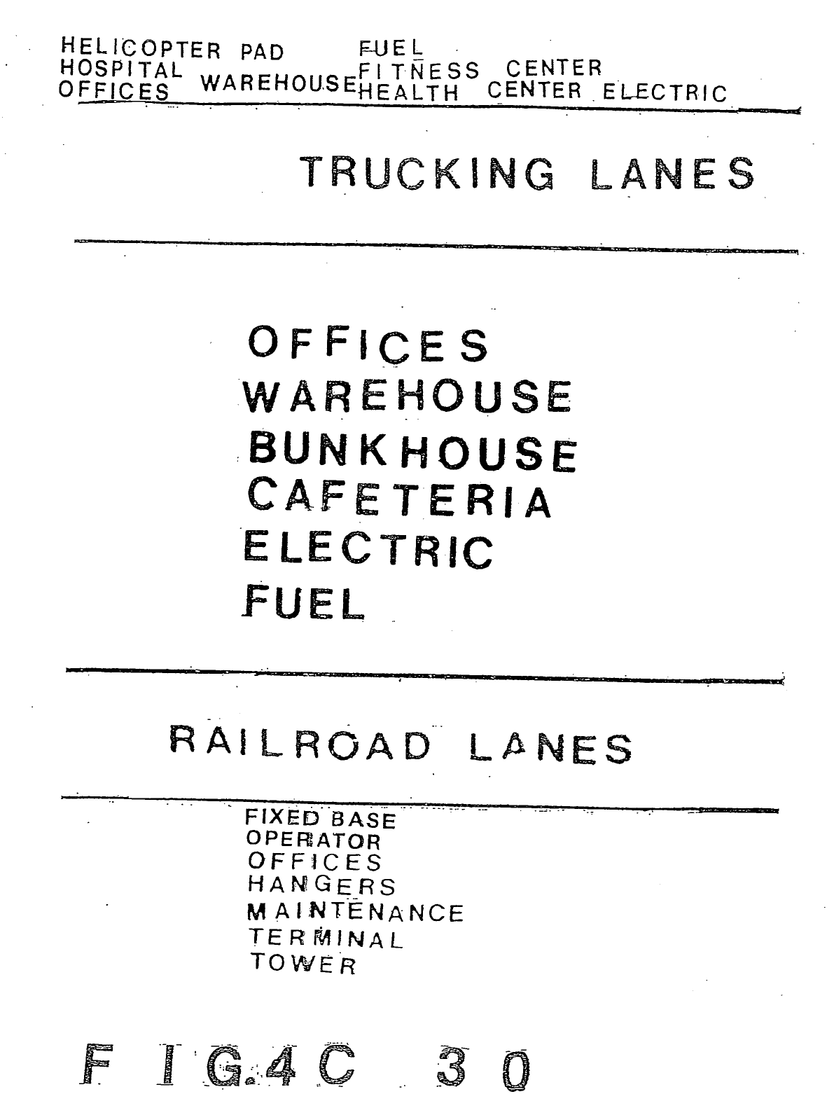

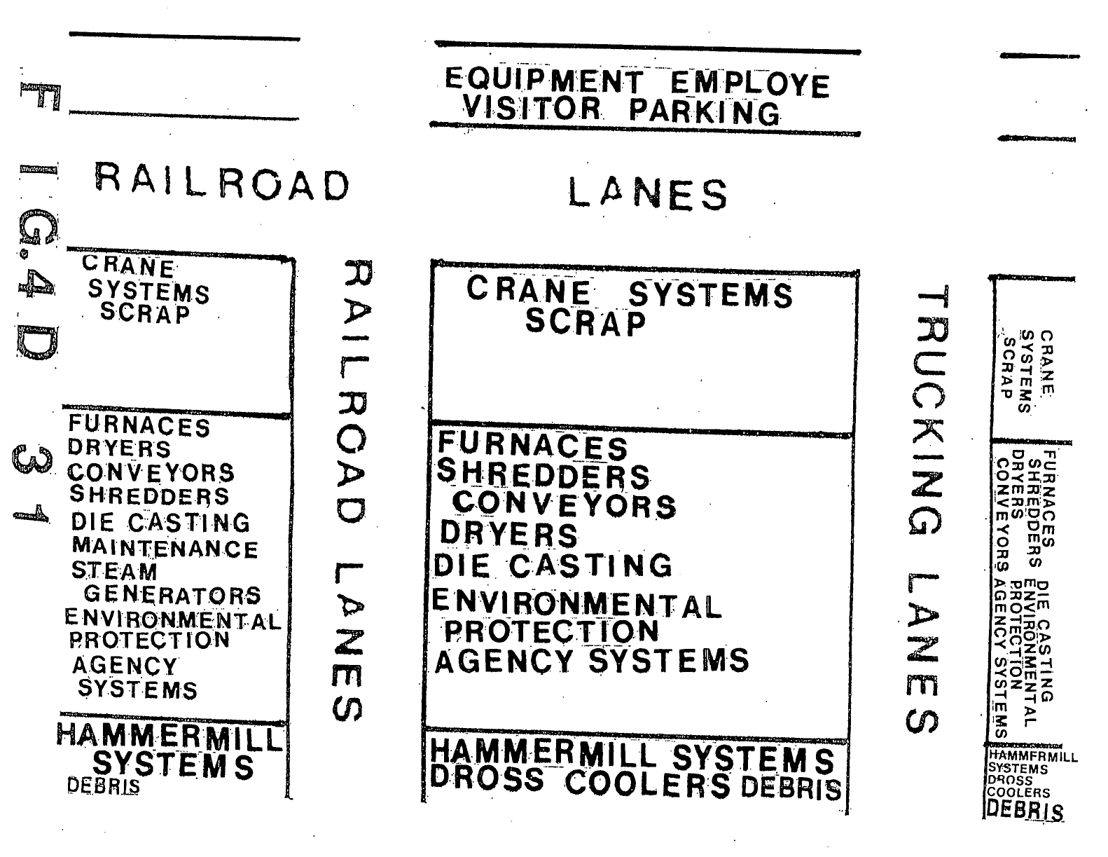

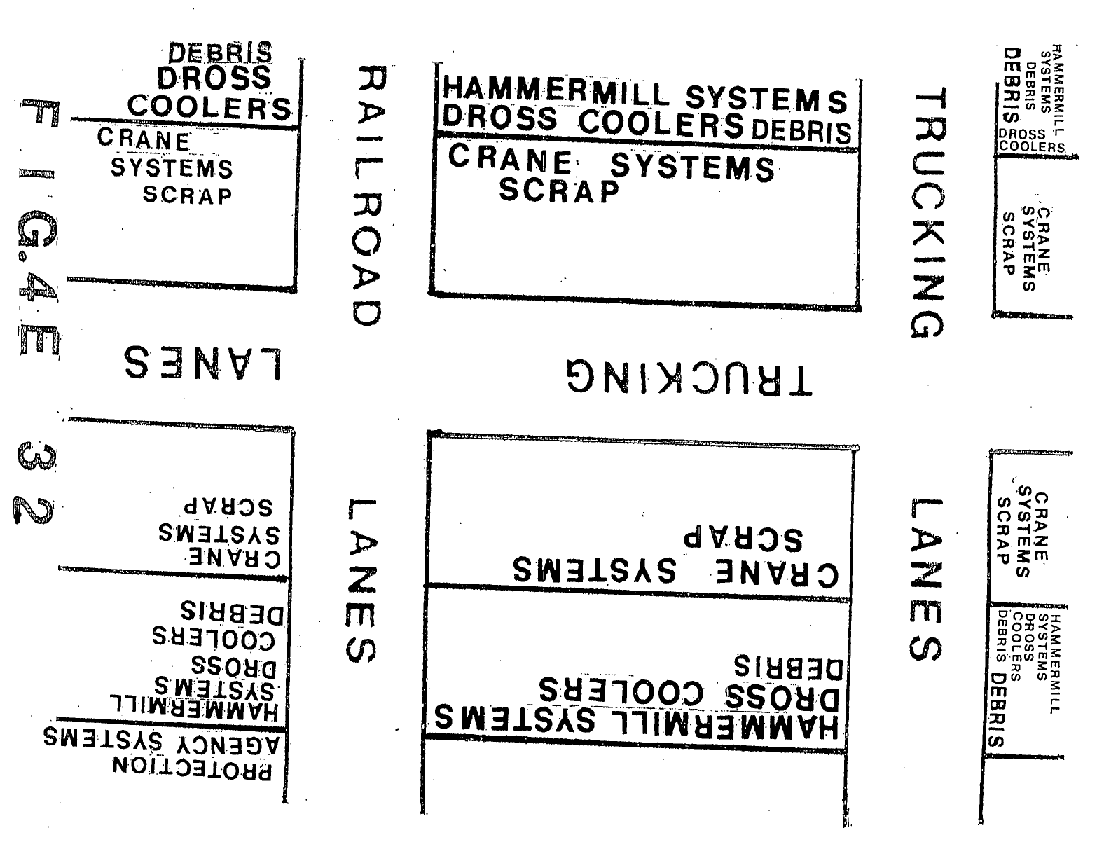

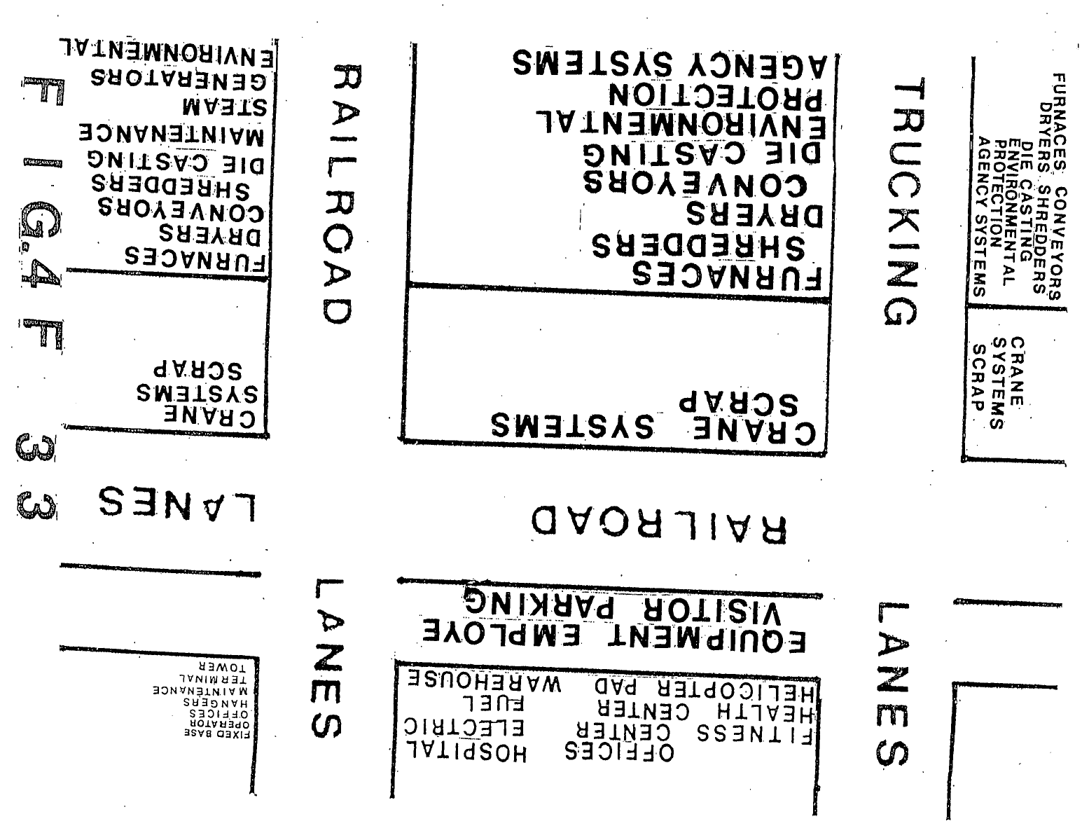

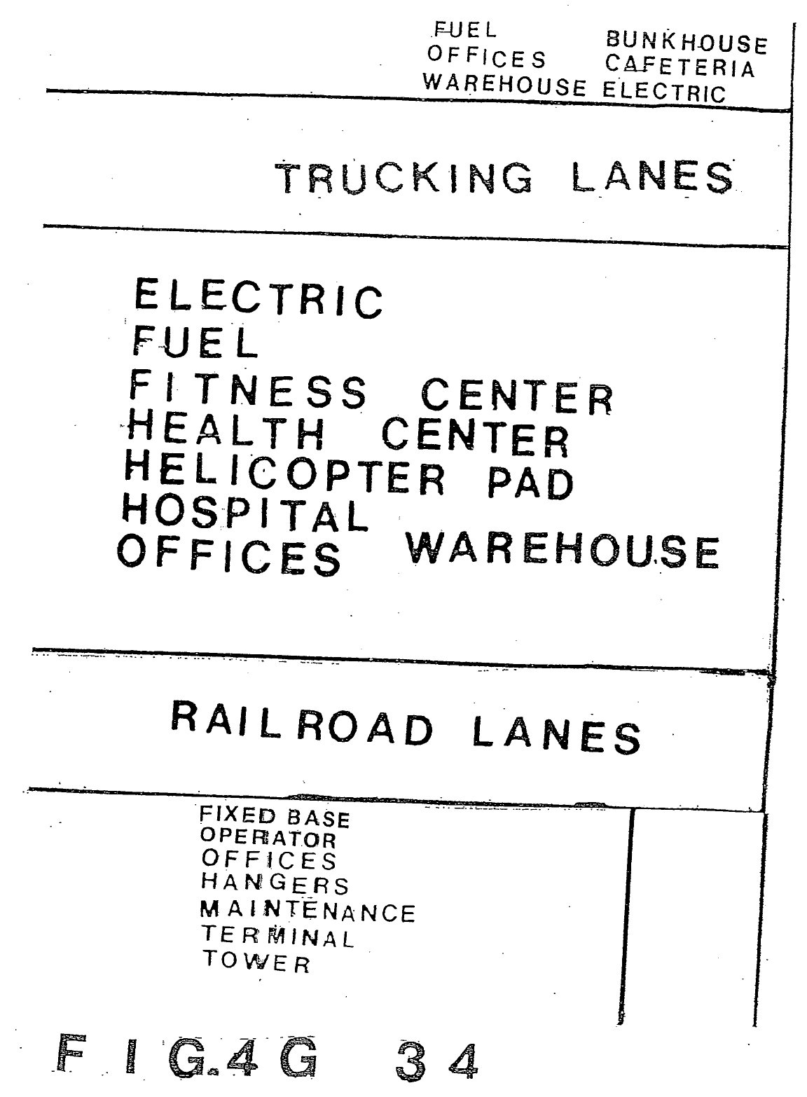

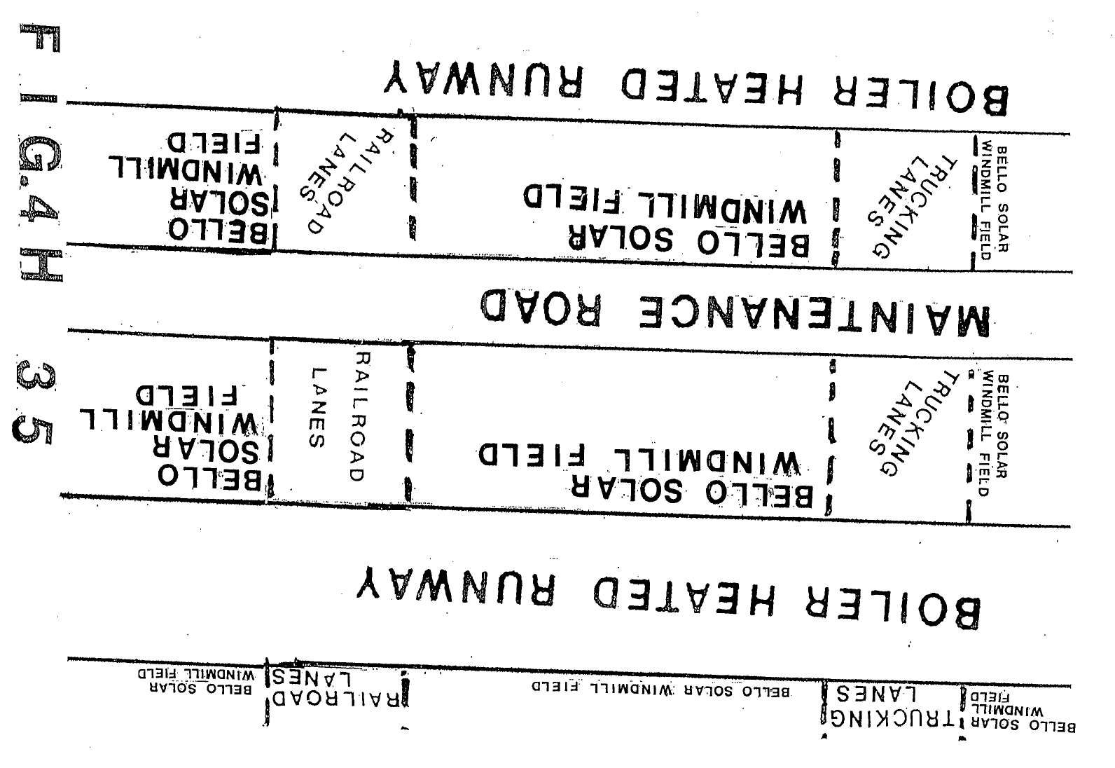

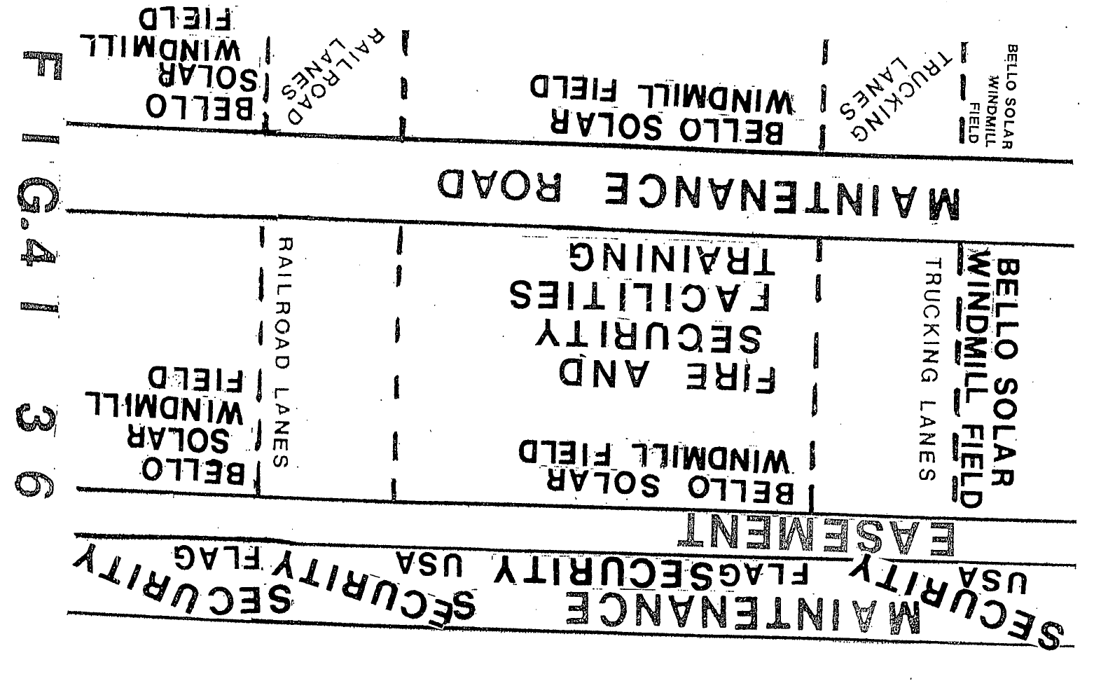

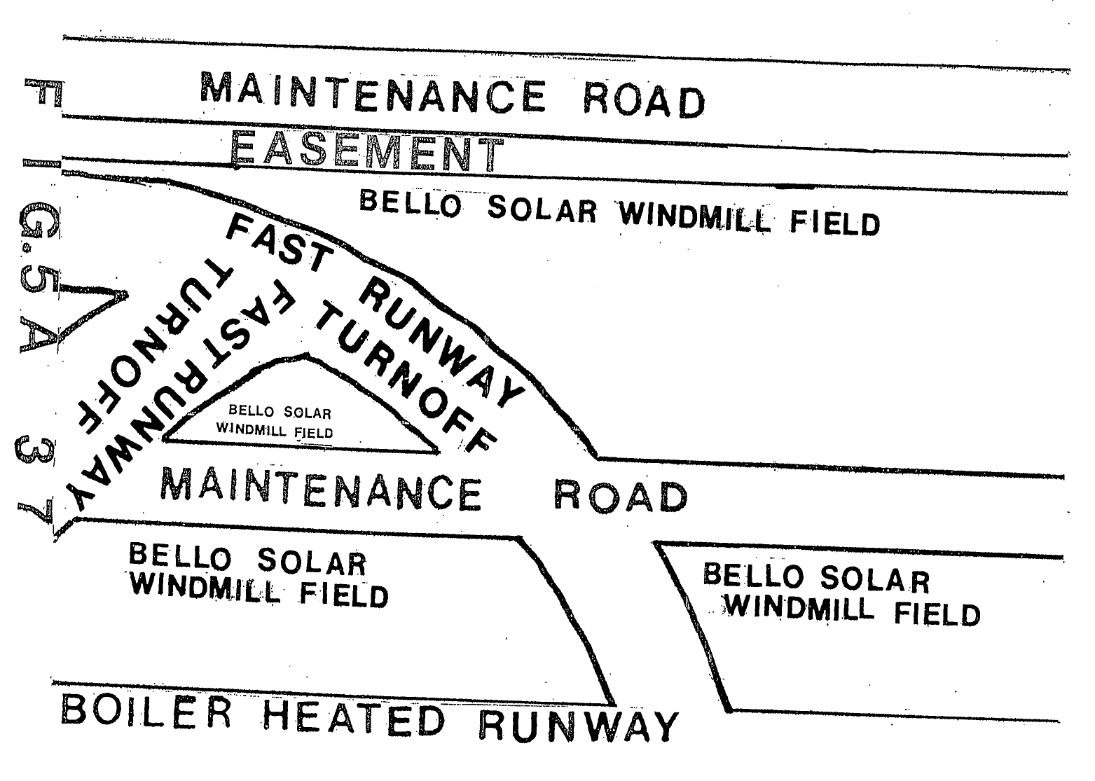

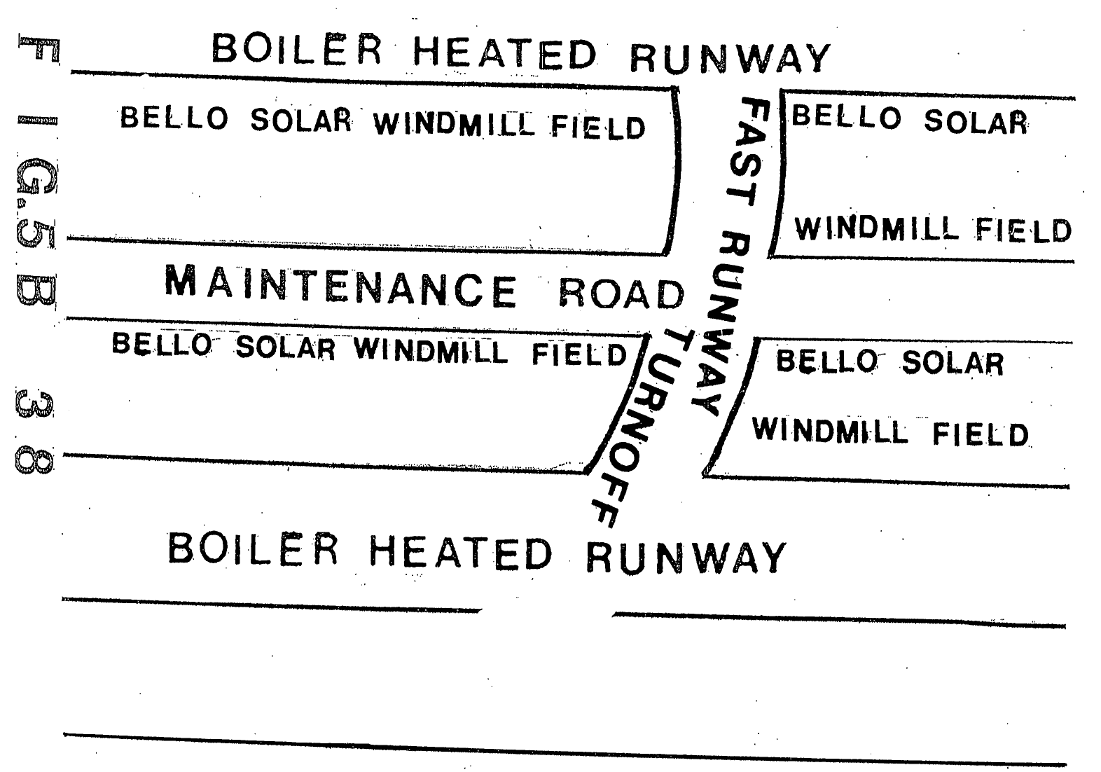

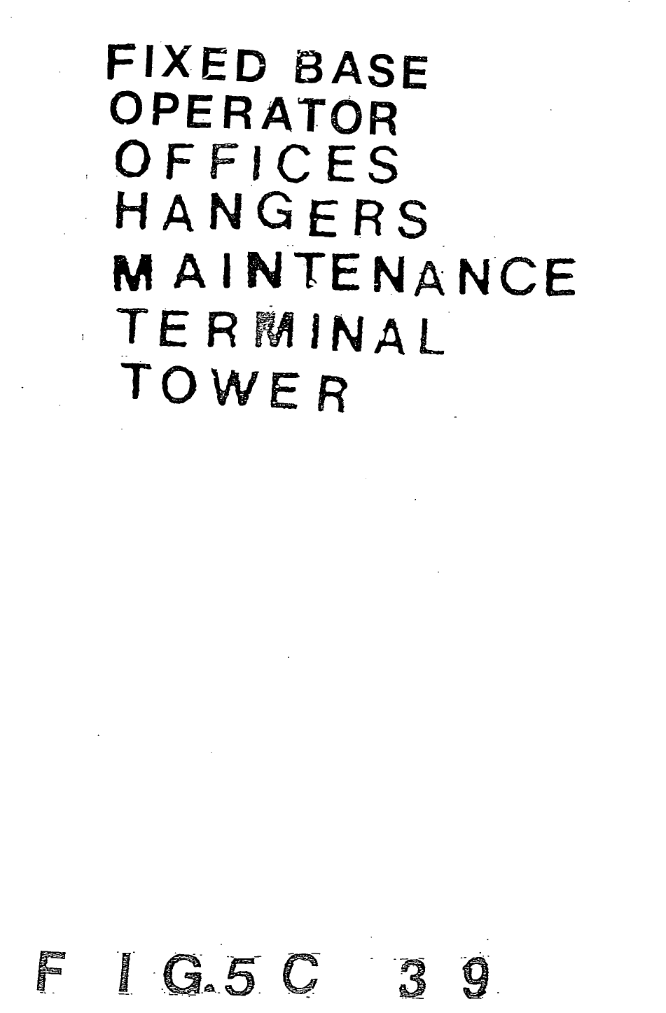

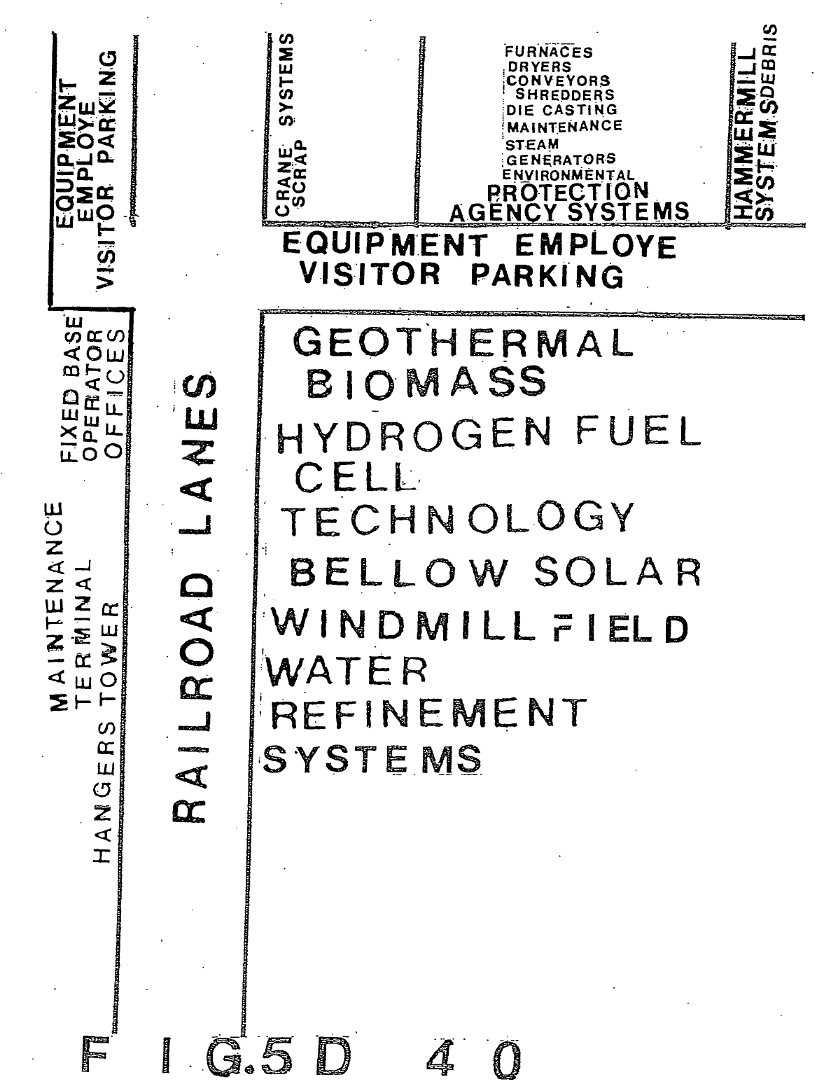

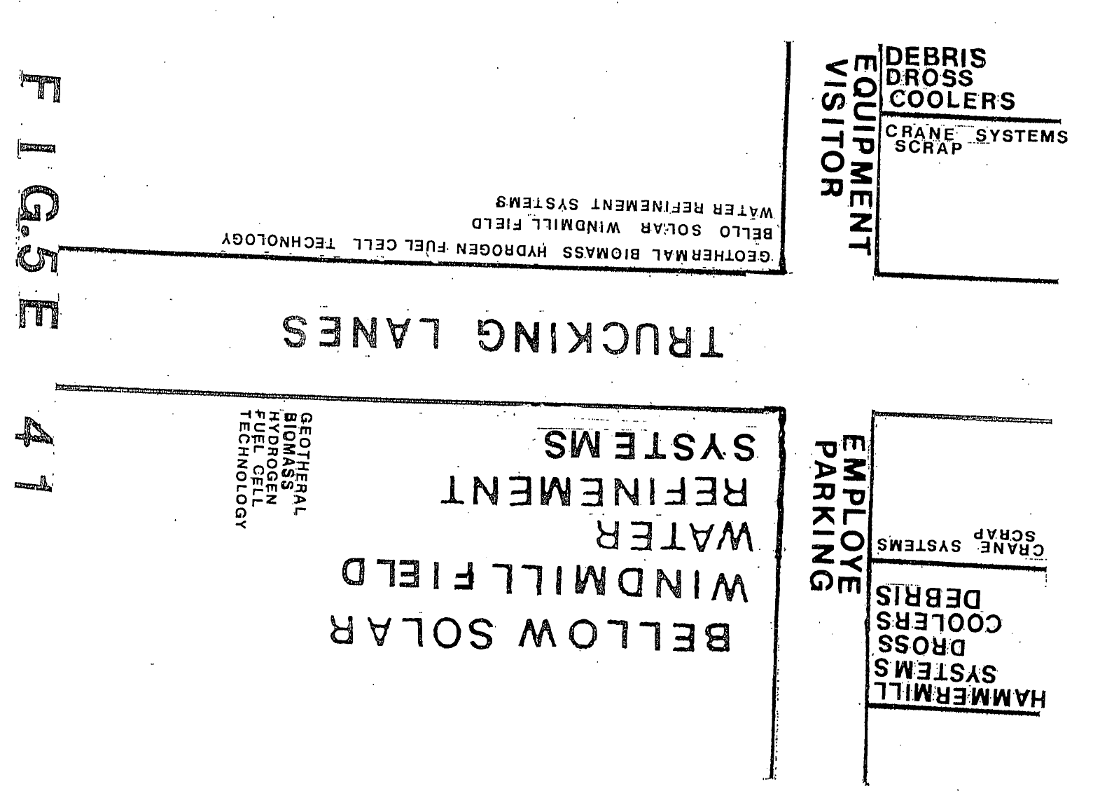

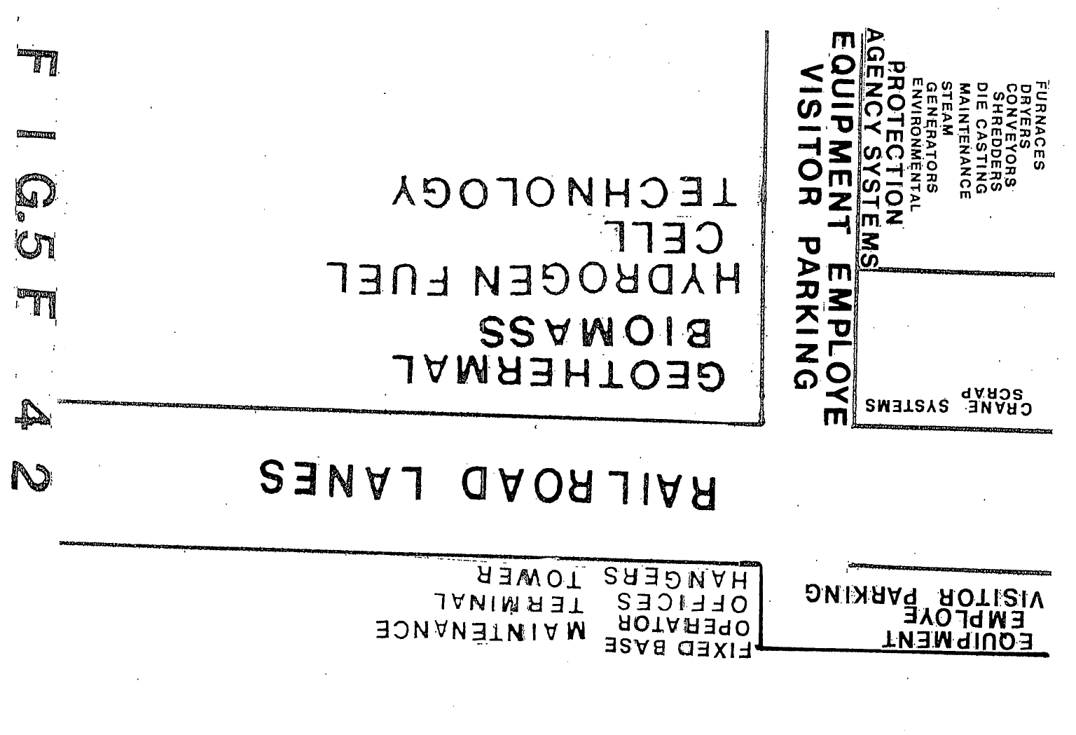

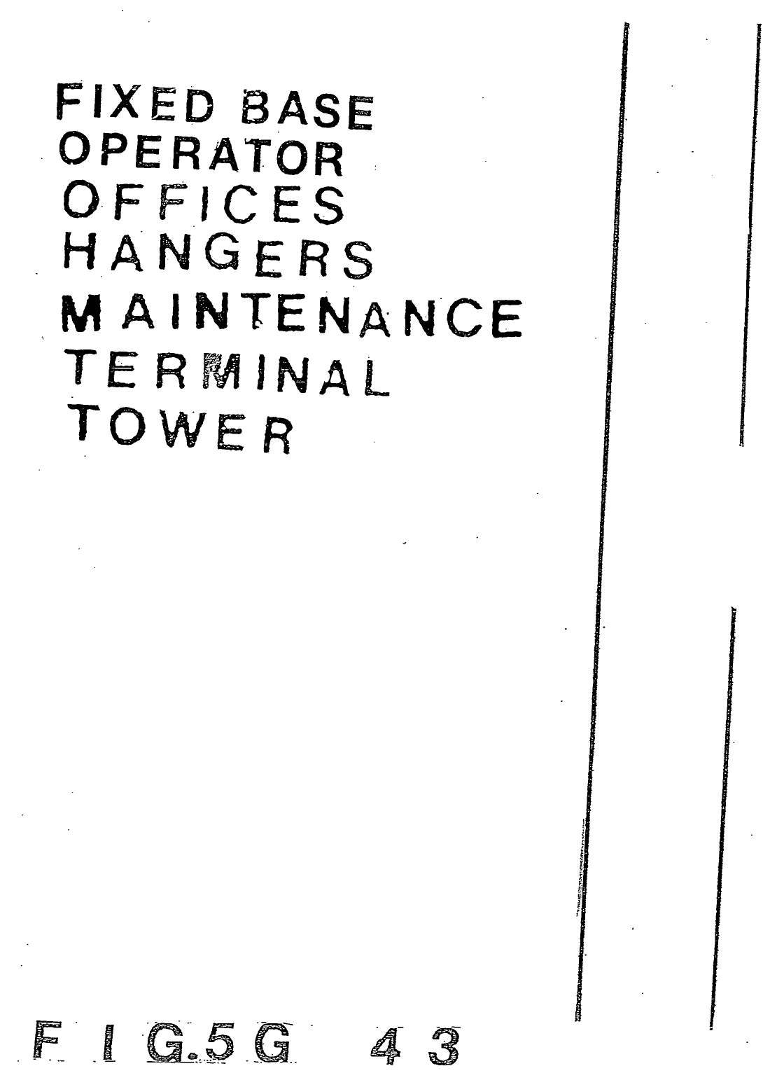

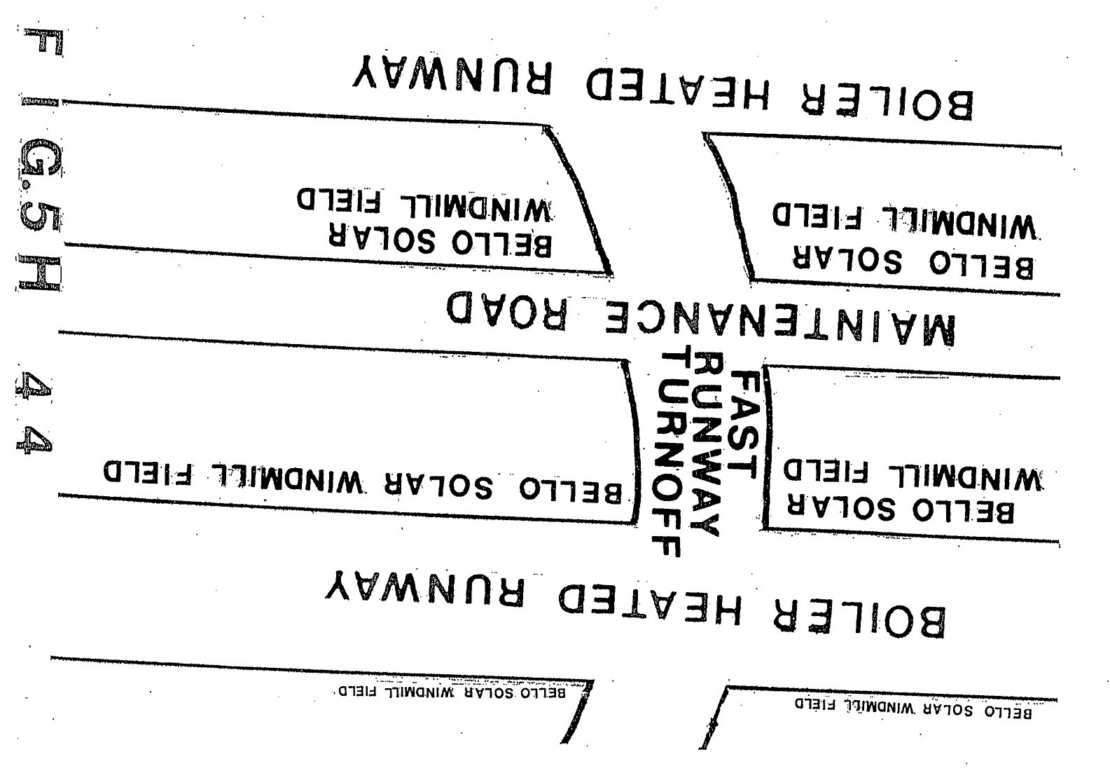

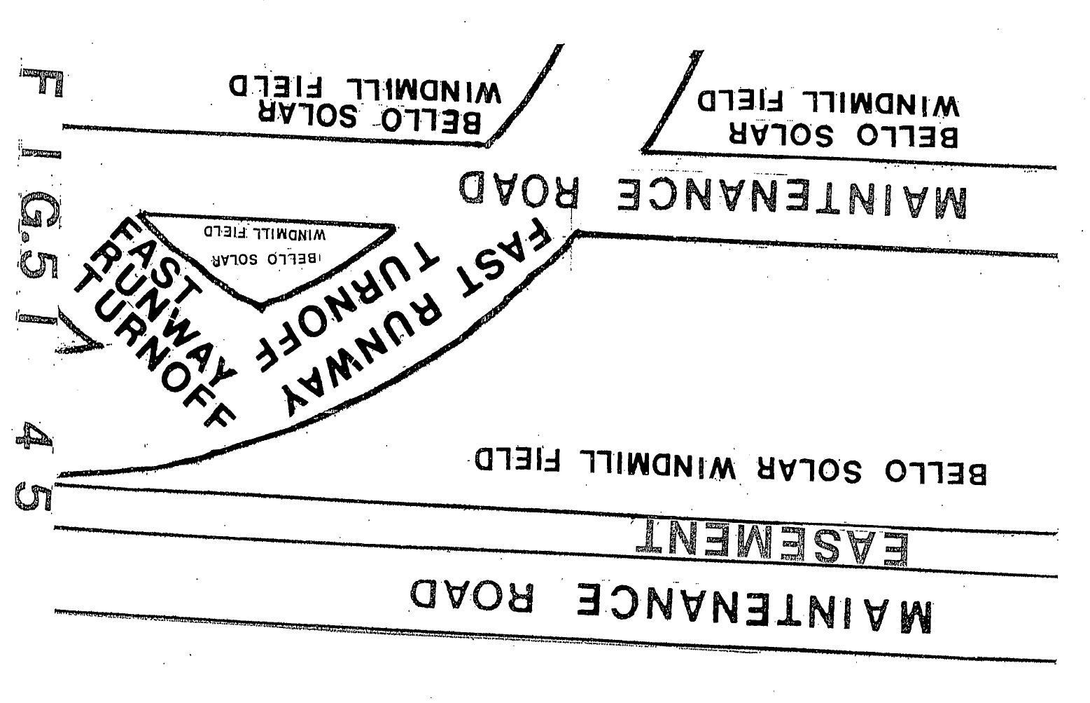

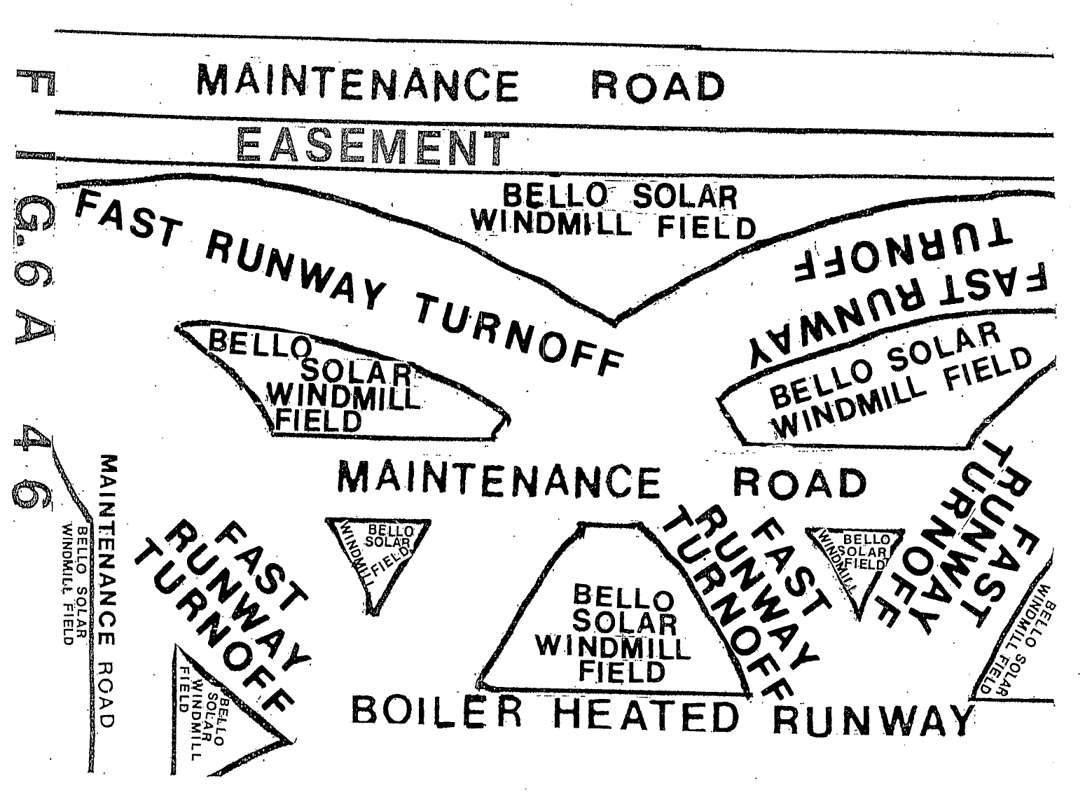

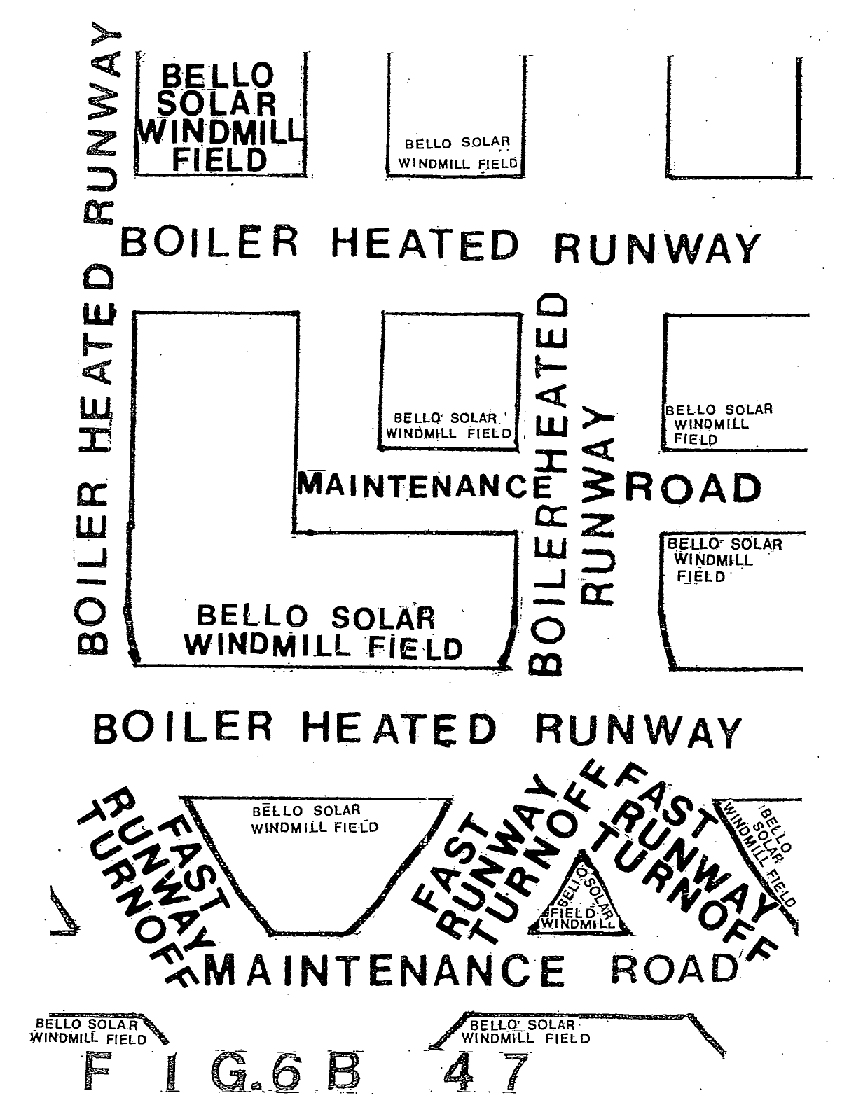

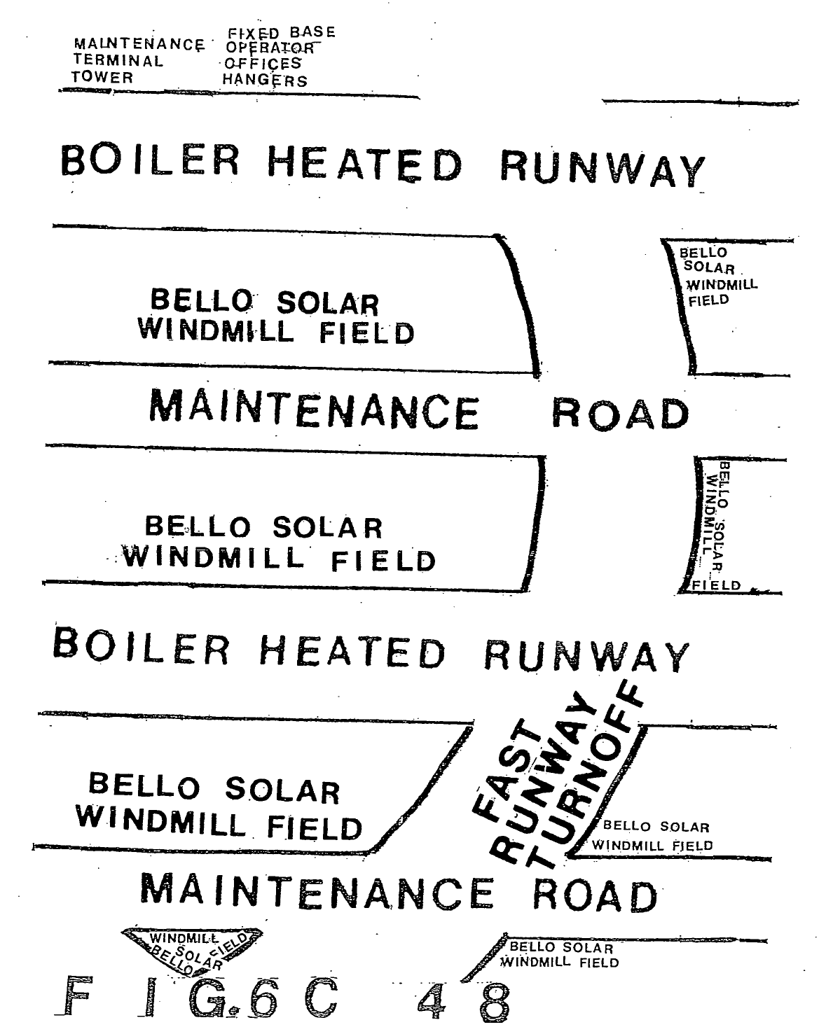

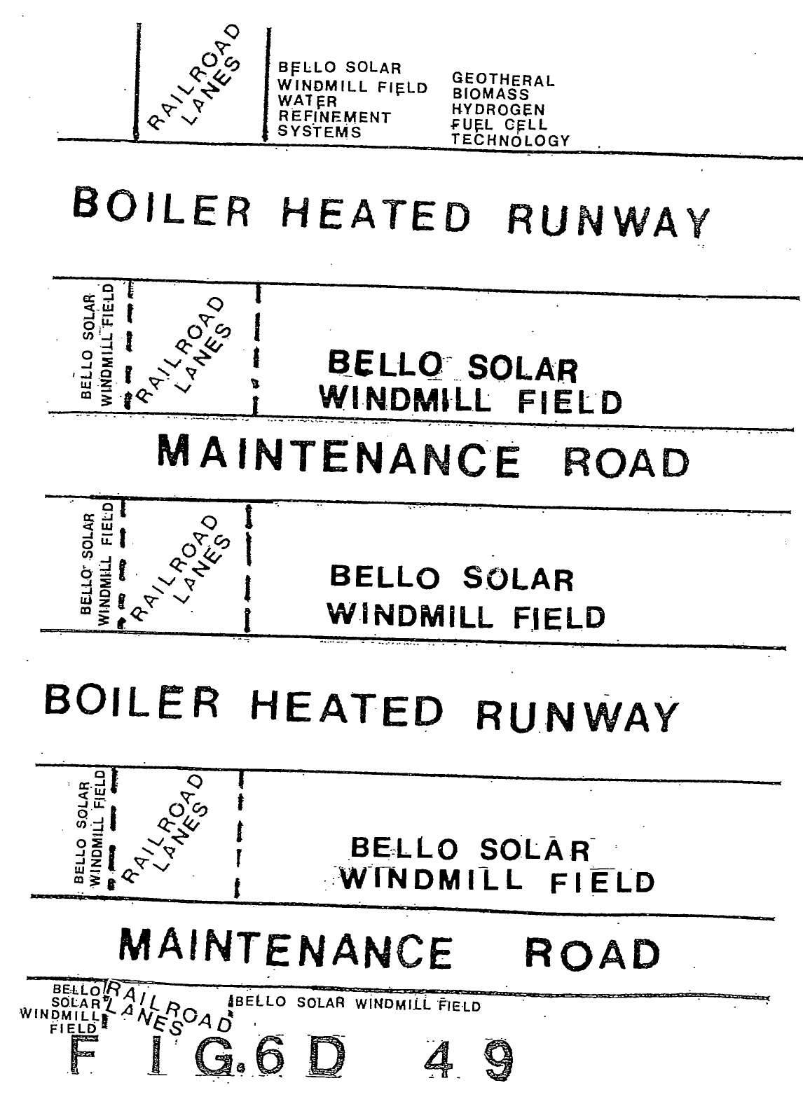

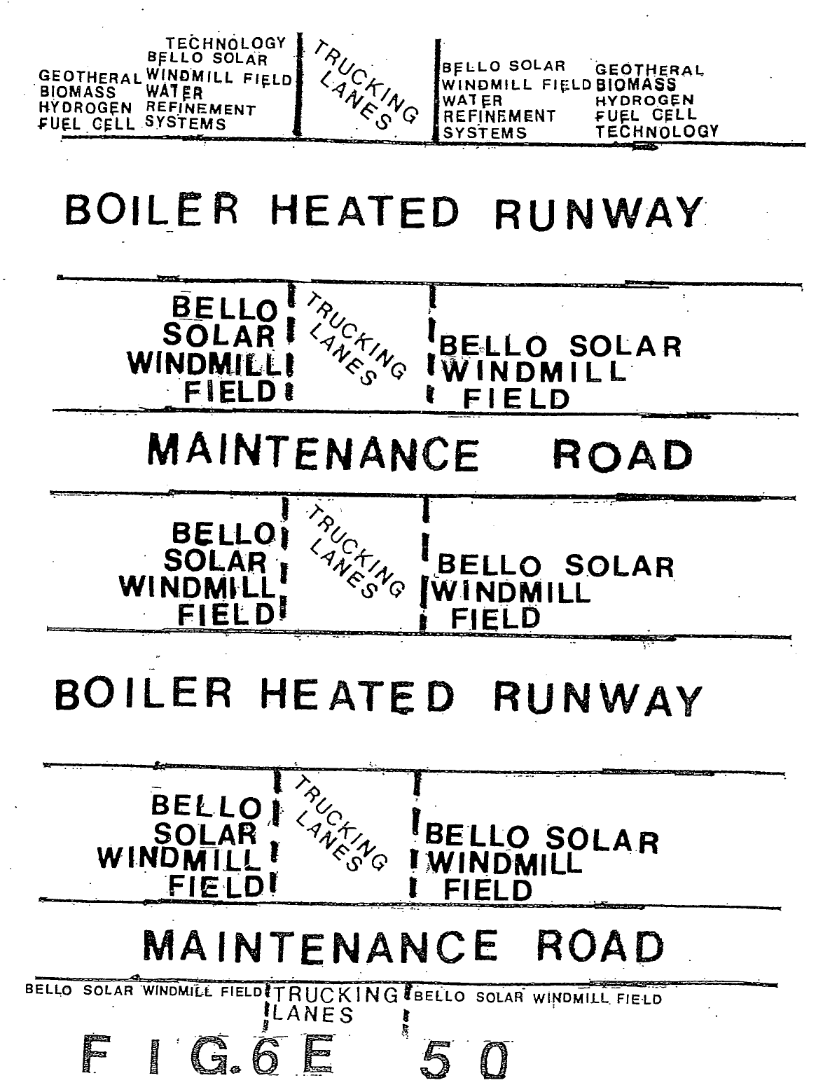

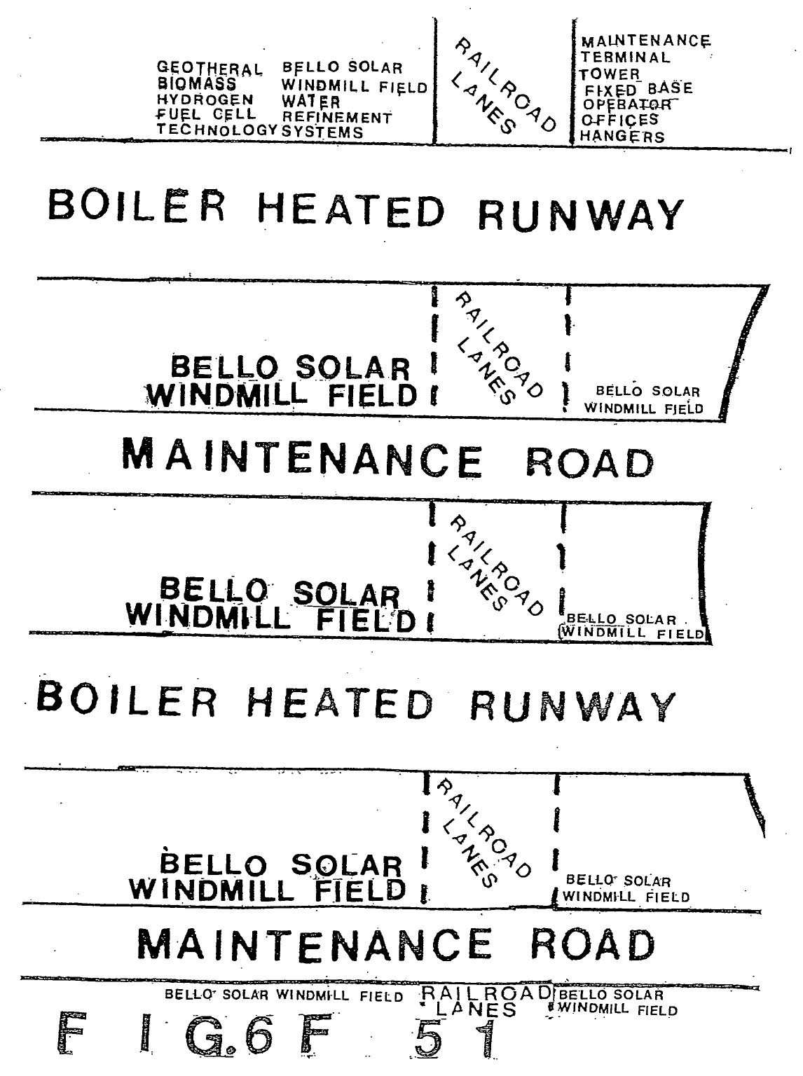

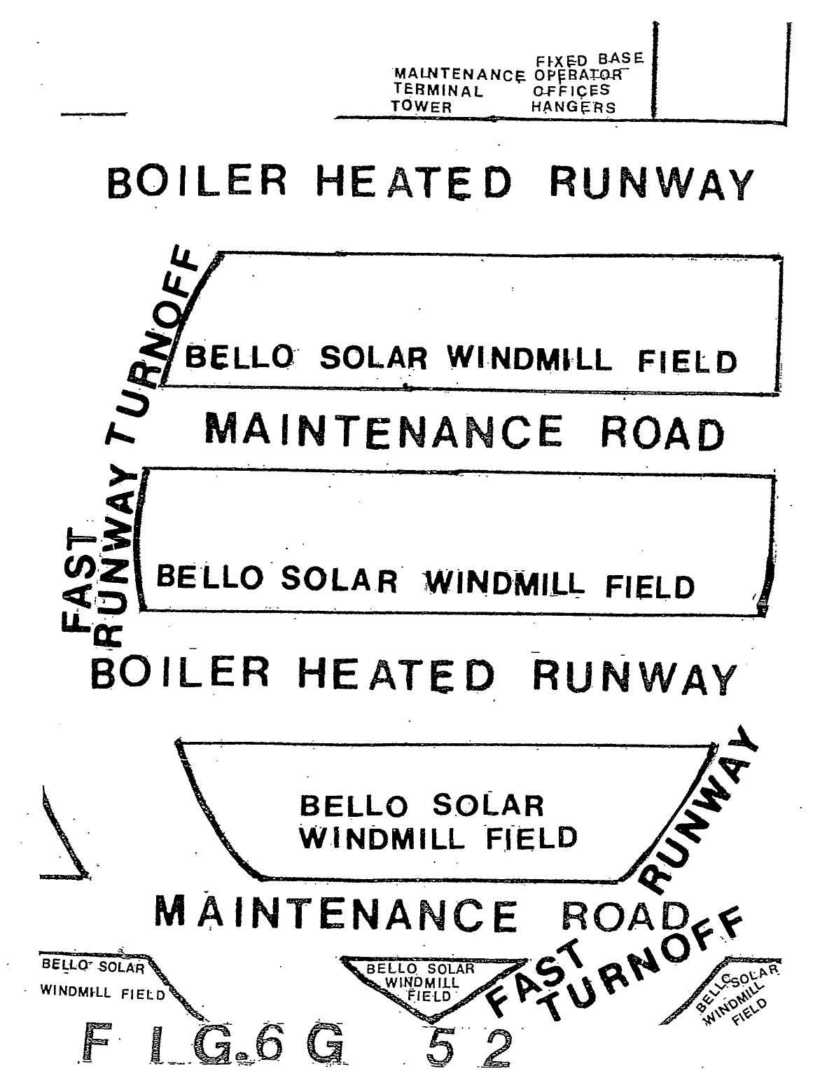

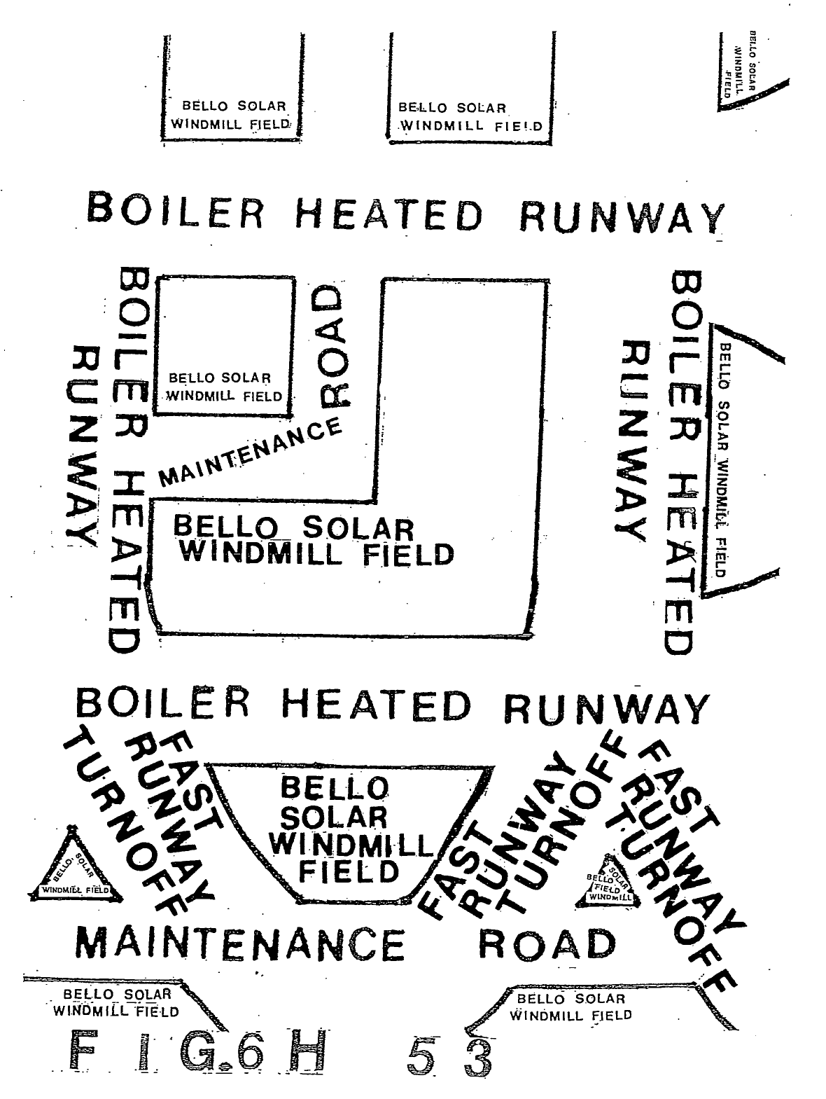

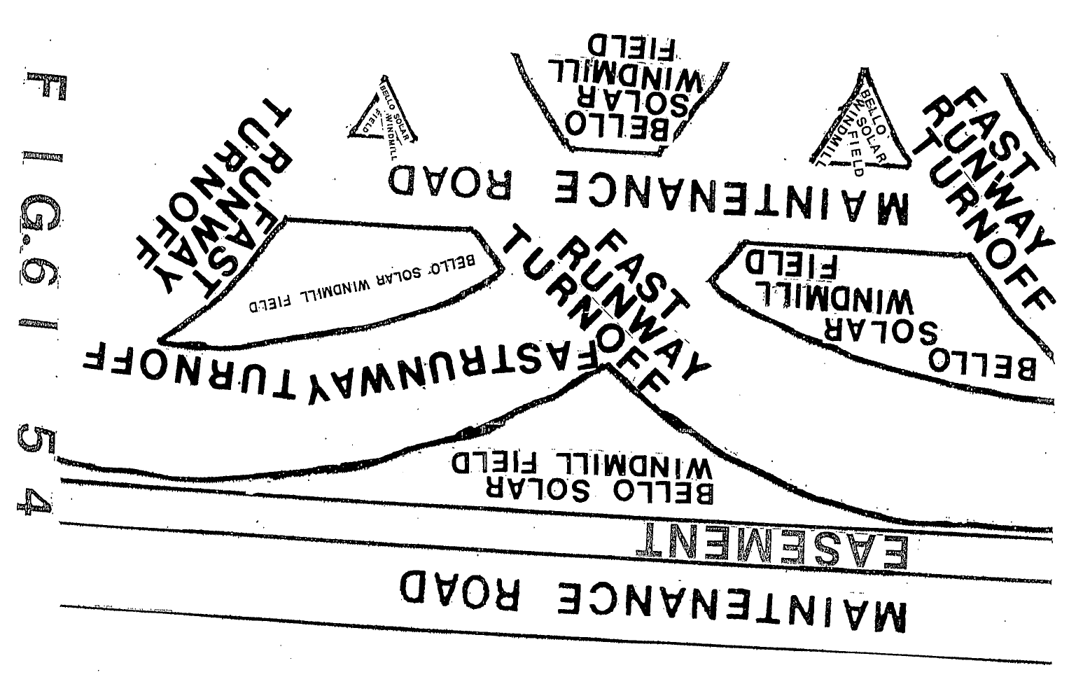

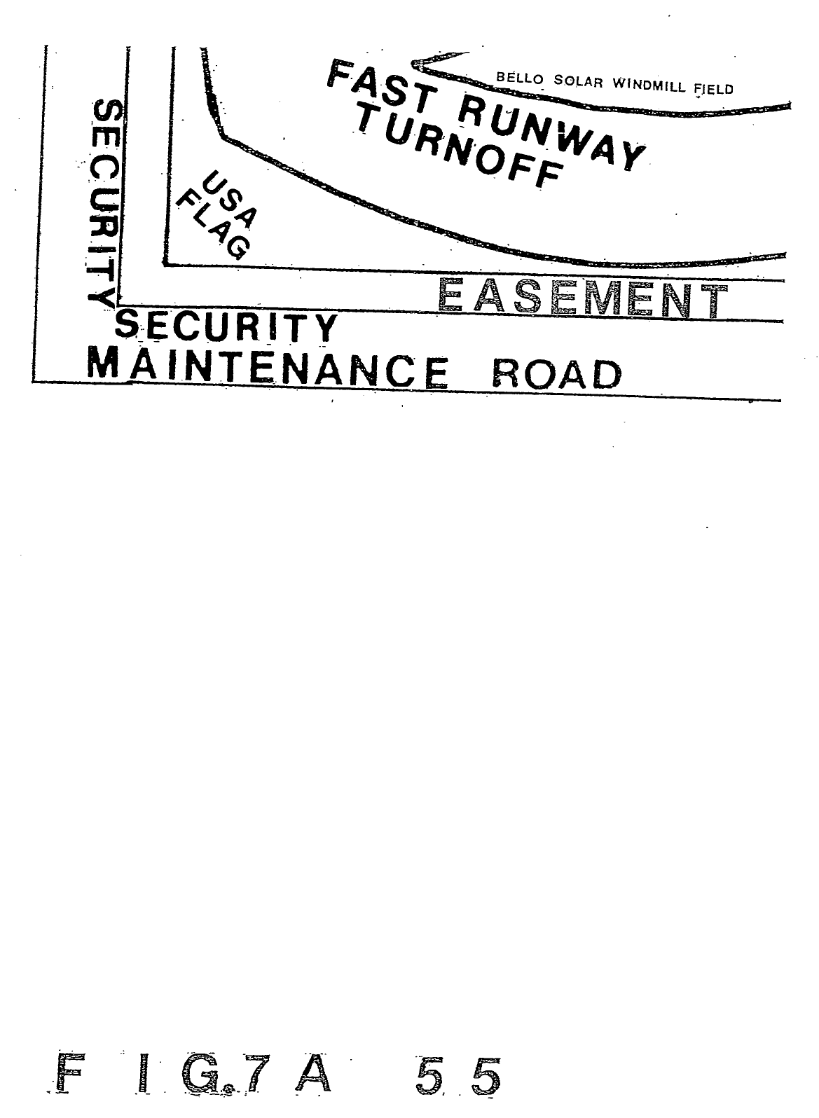

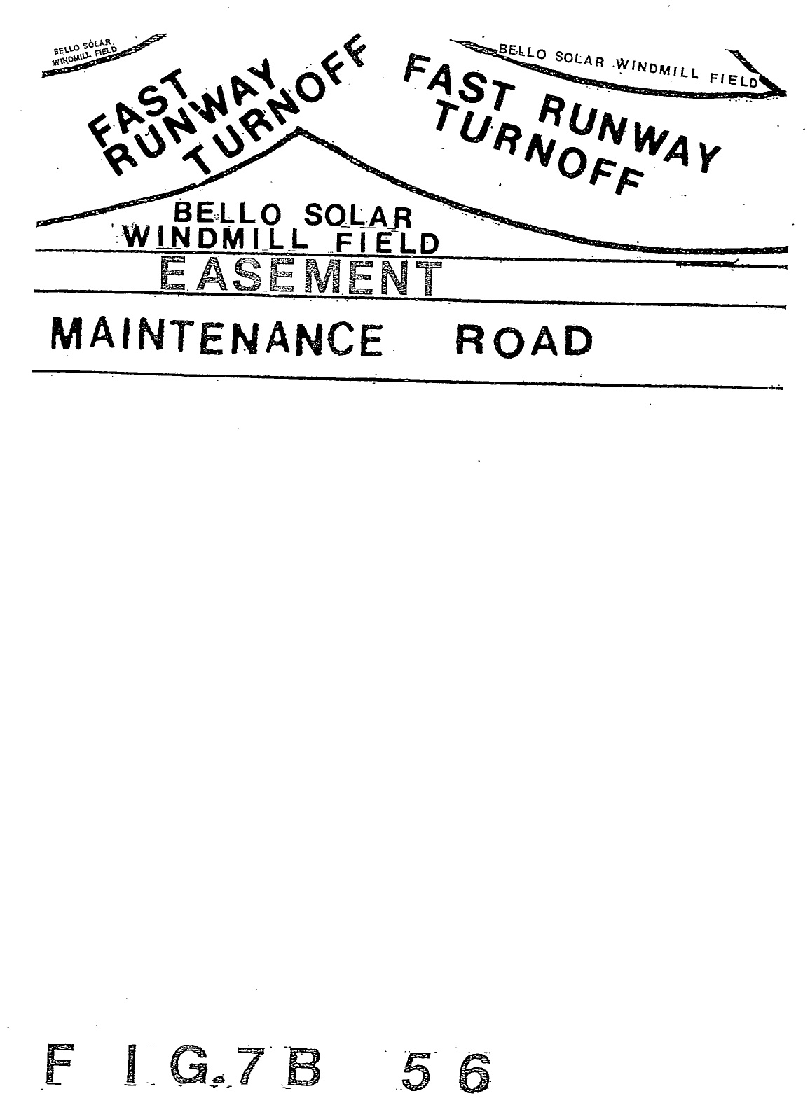

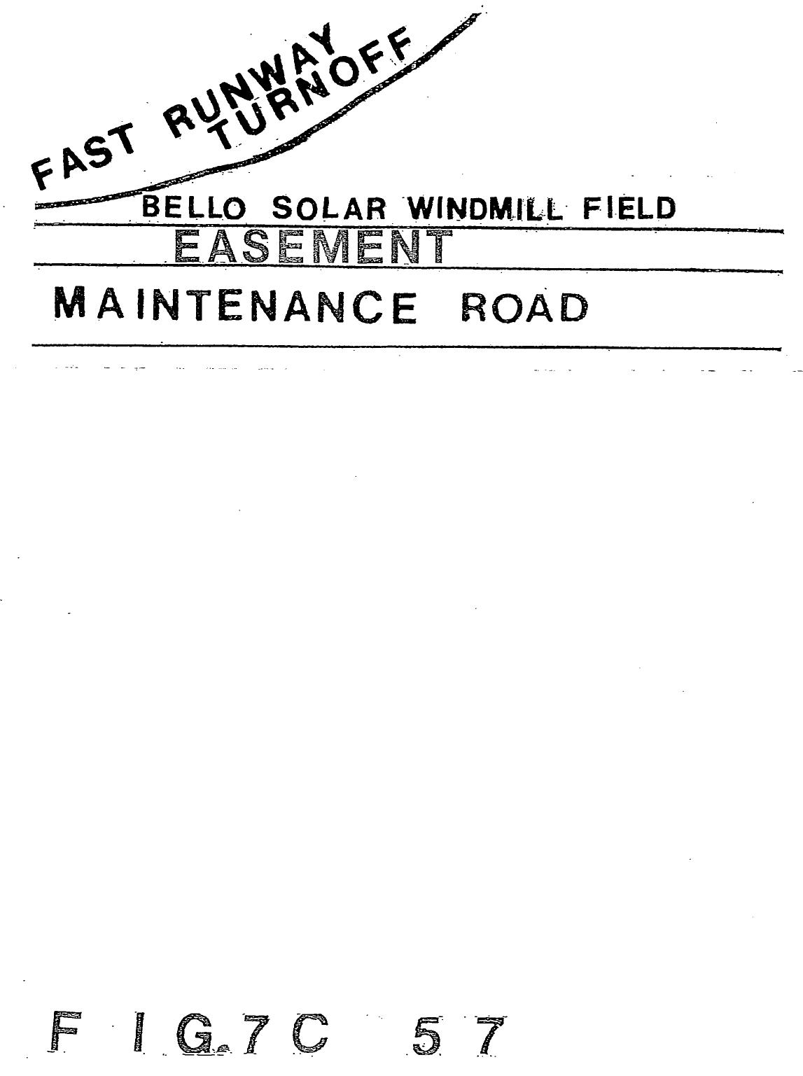

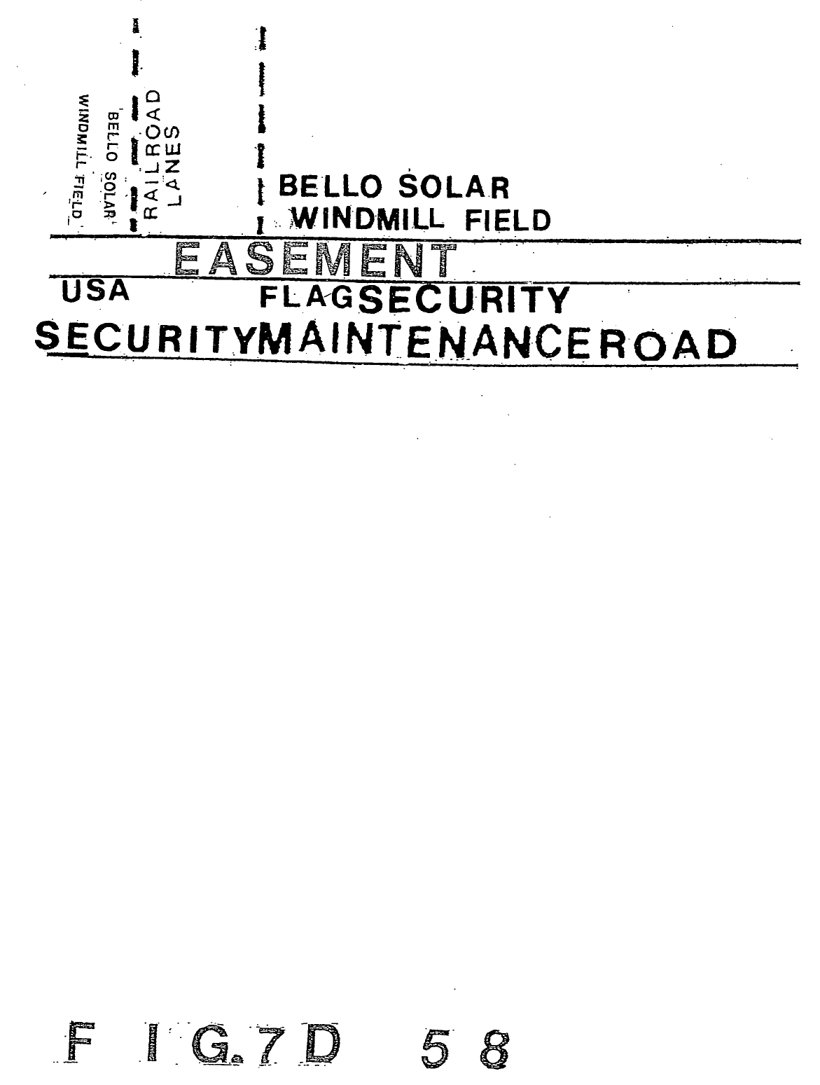

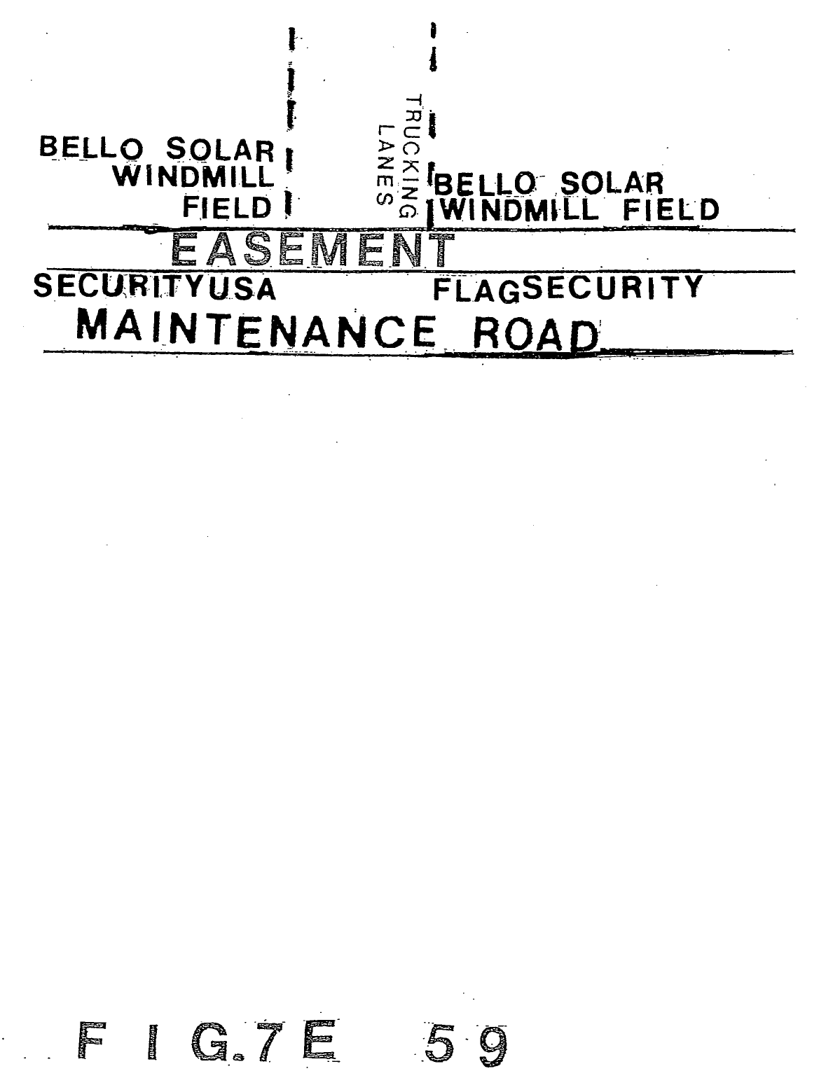

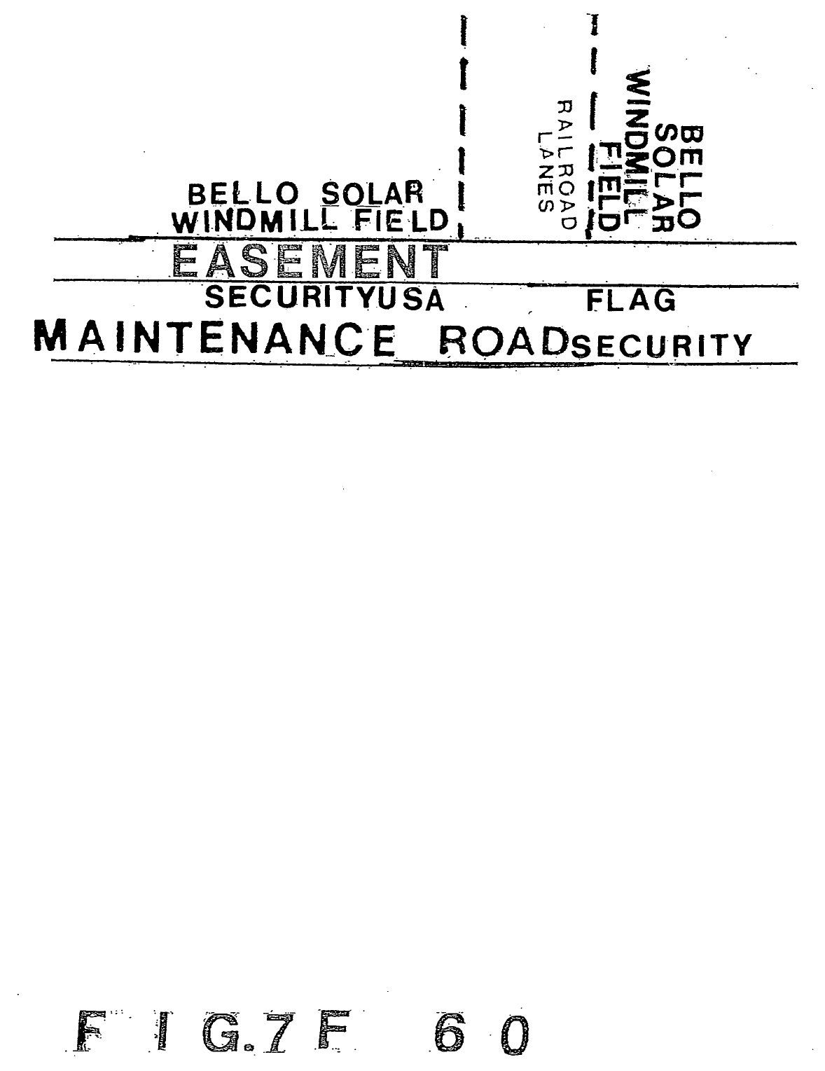

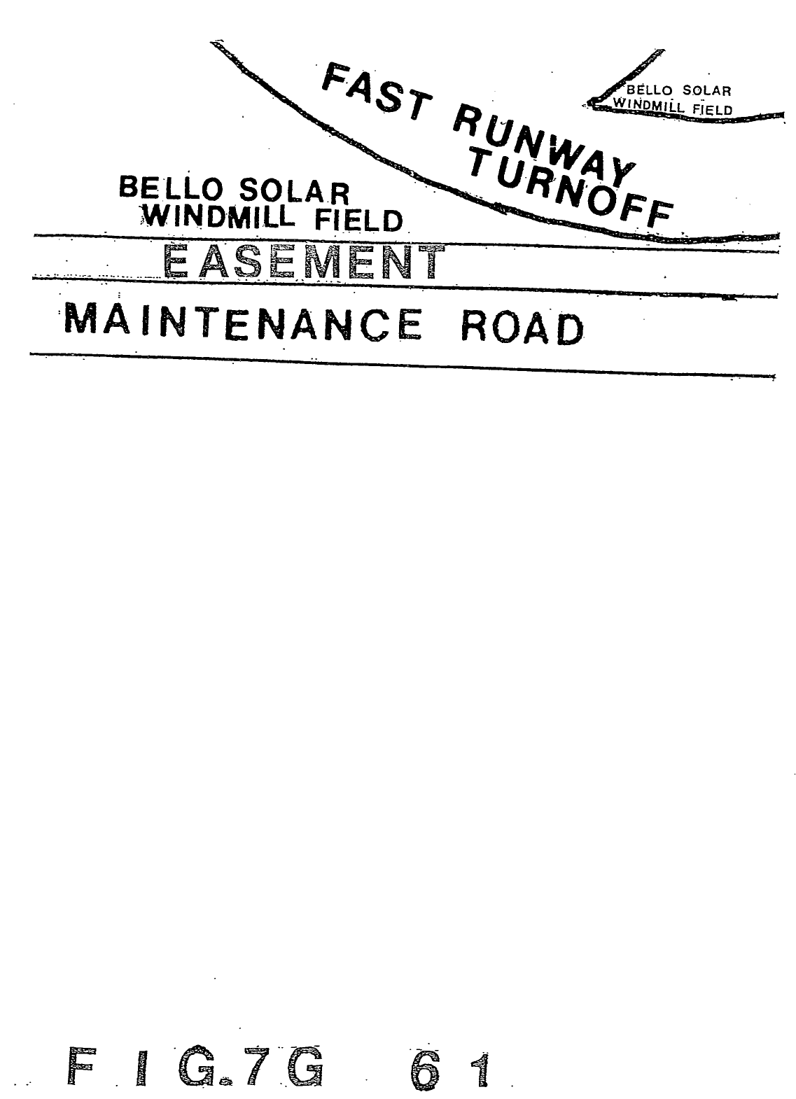

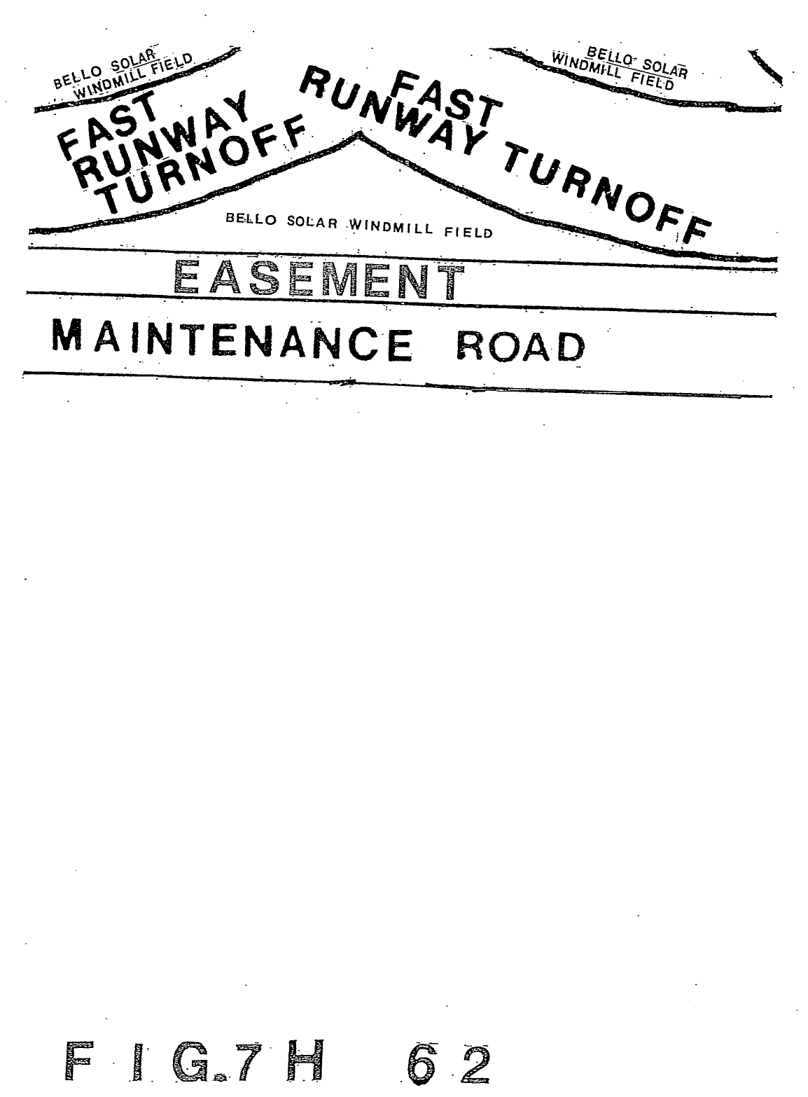

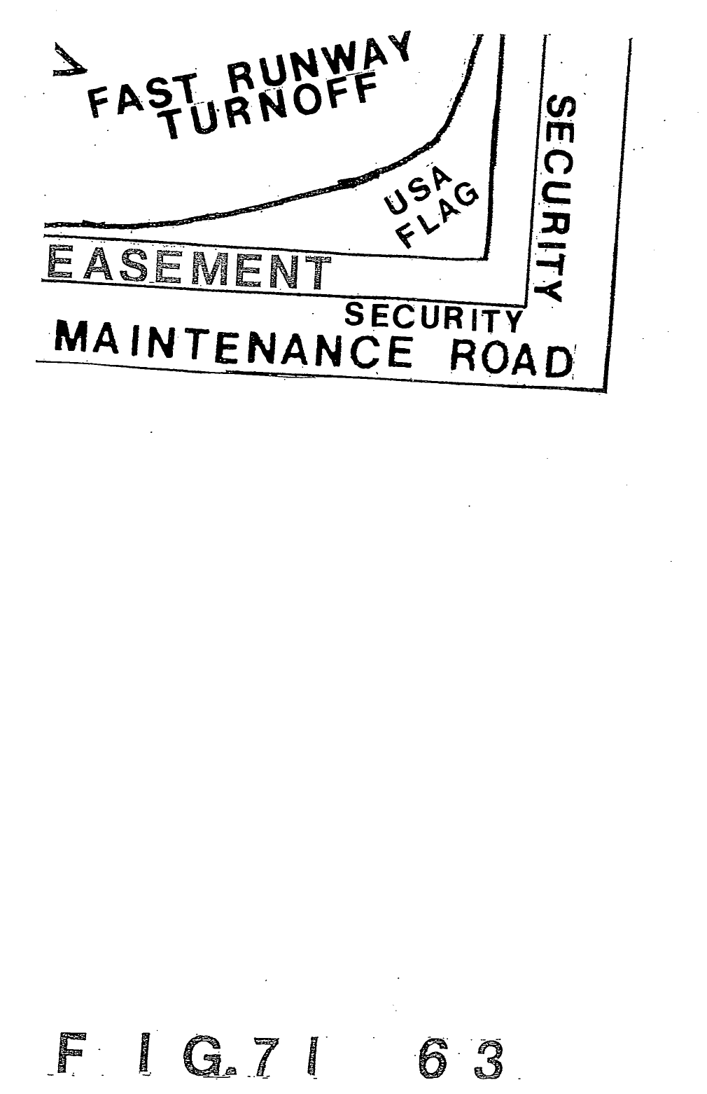

DRAWING AND DRAWINGS WITH VARIABLE SPECIFICATIONS AS INCLUDED WITH PATENT APPLICATION FIGS. 1. THROUGH 12.

1. Adaptable device for spatial and environmental considerations, organizing an existing architectual and or nonarchitectual area and or environment, both made by human and or other.

2. Device according to claim 1, is capable of both process, nonprocess and or other.

3. Device according to claim 2, is environmental considerate.

4. Device according to claim 3, is capable as a multiple and multiple factor, multiple function, multiple task apparatus and apparatusies.

5. Device according to claim 4, is quadrant, section and subsection capable of modification.

6. Device according to claim 5, is interior and exterior transferable both fixed and nonfixed, variable and nonvariable to the device according to claim 1.

7. Device according to claim 5, is variable to considerations of quadrant, section and subsection, as the interior and exterior purposes, and the interior and exterior both fixed and nonfixed, variable and nonvariable apparatus, apparatusies, containments and extainments.
